(19) United States
(12) Patent Application Publication
(10) Pub. No.: US 2024/0320807 A1
(43) Pub. Date: Sep. 26, 2024

(54) IMAGE PROCESSING METHOD AND APPARATUS, DEVICE, AND STORAGE MEDIUM

(71) Applicant: TENCENT TECHNOLOGY (SHENZHEN) COMPANY LIMITED, Shenzhen (CN)

(72) Inventors: Ligeng ZHONG, Shenzhen (CN); Yunquan ZHU, Shenzhen (CN); Wenran LIU, Shenzhen (CN); Wei WEN, Shenzhen (CN)

(21) Appl. No.: 18/734,620

(22) Filed: Jun. 5, 2024

Related U.S. Application Data
(63) Continuation of application No. PCT/CN2023/105718, filed on Jul. 4, 2023.

(30) Foreign Application Priority Data
Aug. 26, 2022 (CN) 202211029204.9

(51) Int. Cl. G06T 5/77; G06V 10/75

(52) U.S. Cl. CPC G06T 5/77; G06V 10/751; G06T 2207/20036

(57) ABSTRACT

An image processing method includes: performing mask processing on a first-type object included in an obtained target video frame image to obtain a candidate image; performing inpainting processing on the first-type object in the candidate image to obtain a first inpainting image, and generating an image initial mask template based on an initial blurred region; performing, when a first quantity of initial blurred pixels included in the image initial mask template reaches a first threshold, morphological processing on a blurred region corresponding to the initial blurred pixel to obtain an image target mask template; performing, when a second quantity of intermediate blurred pixels included in the image target mask template reaches a second threshold, inpainting processing on a pixel region corresponding to the intermediate blurred pixel in the first inpainting image, to obtain a second inpainting image; and determining a target inpainting image based on the second inpainting image.

### CROSS-REFERENCES TO RELATED APPLICATIONS

This application is a continuation PCT application No. PCT/CN2023/105718 filed on Jul. 4, 2023, which claims priority to Chinese Patent Application No. 202211029204.9 filed on Aug. 26, 2022, the entire contents of both of which are incorporated herein by reference.

### FIELD OF THE TECHNOLOGY

The present disclosure relates to the field of image processing technologies, and in particular, to an image processing method and apparatus, a device, a storage medium, and a program product.

### BACKGROUND OF THE DISCLOSURE

With development of science and technology, more and more application programs support video playback. A video is processed before being played. To ensure accuracy of video processing, a video padding technology is proposed to process a video frame image in a video.

Currently, the video padding technology includes: a mode based on an optical flow and a mode based on a neural network model. However, the mode based on an optical flow is only applicable to videos with simple movement in a background, and is not applicable to videos having object occlusion or videos with complex movement occurring in the background. The padding processing performed based on a neural network model often relies on a single model. However, a generation capability of the single model is limited. In a case in which a texture is complex and an object is occluded, padding content is blurred, and image quality of the video frame image cannot be ensured.

Therefore, how to ensure accuracy of image processing in a case in which an object is occluded and/or a background texture is complex, and further improve image quality of a processed video frame image is a technical problem that currently needs to be solved.

### SUMMARY

The present disclosure provides an image processing method and apparatus, a device, a storage medium, and a program product, so as to ensure accuracy of image processing and improve image quality of a processed video frame image.

According to a first aspect, an embodiment of the present disclosure provides an image processing method, including: performing mask processing on a first-type object included in an obtained target video frame image, to obtain a candidate image after mask processing; the first-type object being an image element for inpainting; performing inpainting processing on the first-type object in the to-be-processed image to obtain a first inpainting image, and generating a corresponding image initial mask template based on an initial blurred region in the first inpainting image; performing, when a first quantity of initial blurred pixels included in the image initial mask template reaches a first threshold, morphological processing on an initial blurred region corresponding to the initial blurred pixel to obtain an image target mask template; performing, when a second quantity of intermediate blurred pixels included in the image target mask template reaches a second threshold, inpainting processing on a pixel region corresponding to the intermediate blurred pixel in the first inpainting image, to obtain a second inpainting image; and determining a target inpainting image corresponding to the to-be-processed image based on the second inpainting image.

According to a second aspect, an embodiment of the present disclosure provides an image processing apparatus, including: a first processing unit, configured to perform mask processing on a first-type object included in an obtained target video frame image, to obtain a to-be-processed image after mask processing; the first-type object being an image element for inpainting; a second processing unit, configured to: perform inpainting processing on the first-type object in the to-be-processed image to obtain a first inpainting image, and generate a corresponding image initial mask template based on an initial blurred region in the first inpainting image; a third processing unit, configured to: perform, when a first quantity of initial blurred pixels included in the image initial mask template reaches a first threshold, morphological processing on an initial blurred region corresponding to the initial blurred pixel to obtain an image target mask template; a fourth processing unit, configured to: perform, when a second quantity of intermediate blurred pixels included in the image target mask template reaches a second threshold, inpainting processing on a pixel region corresponding to the intermediate blurred pixel in the first inpainting image, to obtain a second inpainting image; and a determining unit, configured to determine a target inpainting image corresponding to the to-be-processed image based on the second inpainting image.

According to a third aspect, an embodiment of the present disclosure provides an electronic device, including: a memory and a processor, where the memory is configured to store computer instructions; and the processor is configured to execute the computer instructions to implement the operations of the image processing method provided in the embodiments of the present disclosure.

According to a fourth aspect, an embodiment of the present disclosure provides a non-transitory computer-readable storage medium, having computer instructions stored therein, the computer instructions, when executed by a processor, implementing the operations of the image processing method provided in the embodiments of the present disclosure.

Beneficial effects of the embodiments of the present disclosure are as follows:

In the embodiments of the present disclosure, image inpainting is decomposed into three phases, an obtained first inpainting image is further detected in the first phase, and a corresponding image initial mask template is generated. In the second phase, when it is determined that a first quantity of initial blurred pixels included in the image initial mask template reaches a first threshold, morphological processing is performed on a blurred region corresponding to the initial blurred pixel to connect different blurred regions, so as to obtain an image target mask template, thereby avoiding unnecessary processing on a smaller blurred region, and improving processing efficiency. In the third phase, when it is determined that a second quantity of intermediate blurred pixels included in the image target mask template reaches a second threshold, it is determined that an object contour that needs to be complemented exists in the first inpainting image, so as to perform inpainting processing on a pixel region corresponding to the intermediate blurred pixel, to obtain a second inpainting image. Finally, a target inpainting image corresponding to a to-be-processed image is determined based on the second inpainting image. Through cooperation of the foregoing three phases, image quality of the second inpainting image is improved, and image quality of the target inpainting image is ensured.

### BRIEF DESCRIPTION OF THE DRAWINGS

To describe the technical solutions of the embodiments of the present disclosure more clearly, the following briefly introduces the accompanying drawings required for describing the embodiments. Clearly, the accompanying drawings in the following description show only some embodiments of the present disclosure.

FIG. 1 is a schematic diagram of first image processing.

FIG. 2 is a schematic diagram of second image processing.

FIG. 3 is a schematic diagram of an application scenario according to an embodiment of the present disclosure.

FIG. 4 is a flowchart of an image processing method according to an embodiment of the present disclosure.

FIG. 5 is a schematic diagram of performing padding processing on a first-type object according to an embodiment of the present disclosure.

FIG. 6 is a schematic diagram of first image processing according to an embodiment of the present disclosure.

FIG. 7 is a schematic diagram of second image processing according to an embodiment of the present disclosure.

FIG. 8 is a schematic diagram of third image processing according to an embodiment of the present disclosure.

FIG. 9 is a schematic diagram of performing morphological processing on an initial blurred region according to an embodiment of the present disclosure.

FIG. 10 is a schematic diagram of performing inpainting processing on a pixel region corresponding to an intermediate blurred pixel according to an embodiment of the present disclosure.

FIG. 11 is a flowchart of another image processing method according to an embodiment of the present disclosure.

FIG. 12 is a flowchart of a specific implementation method for image processing according to an embodiment of the present disclosure.

FIG. 13 is a schematic diagram of a specific implementation method for image processing according to an embodiment of the present disclosure.

FIG. 14 is a flowchart of a training method for an information propagation model according to an embodiment of the present disclosure.

FIG. 15 is a structural diagram of an image processing apparatus according to an embodiment of the present disclosure.

FIG. 16 is a structural diagram of an electronic device according to an embodiment of the present disclosure.

FIG. 17 is a structural diagram of another electronic device according to an embodiment of the present disclosure.

### DESCRIPTION OF EMBODIMENTS

In order to make objectives, technical solutions, and beneficial effects of the present disclosure clearer, the technical solutions in the embodiments of the present disclosure will be clearly and completely described in the following with reference to the accompanying drawings in the embodiments of the present disclosure. It is clear that the embodiments to be described are only a part rather than all of the embodiments of the present disclosure. All other embodiments obtained by a person of ordinary skill in the art based on the embodiments of the present disclosure without making creative efforts shall fall within the protection scope of the present disclosure.

To facilitate a person skilled in the art to better understand the technical solutions of the present disclosure, the following describes some concepts involved in the present disclosure.

Video inpainting is a technology in which un-occluded region information in a video is configured for inpainting a occluded region, that is, the un-occluded region information is configured for properly inpainting the occluded region. Video inpainting requires two capabilities: One is a capability of using time domain information to propagate available pixels of a frame to a corresponding region of another frame; and the other is a generation capability. If no available pixels exist in another frame, pixel generation needs to be performed on a corresponding region by using space and time domain information.

A visual identity system (VIS) is configured to pre-identify a mask template corresponding to an object in an image.

Mask template: The whole or a part of a to-be-processed image is occluded by using a selected image, graph, or object, to control a region or a processing process of image processing. A specific image or object configured for coverage is referred to as a mask template. In optical image processing, the mask template may refer to a film, a filter, or the like. In digital image processing, a mask template is a two-dimensional matrix array, and sometimes may be a multi-valued image. In digital image processing, an image mask template is mainly configured to: 1. Extract a region of interest, and multiply a mask template of the region of interest by a to-be-processed image to obtain an image of the region of interest, where an image value in the region of interest remains unchanged, and image values outside the region are all 0. 2. Occlusion function: Occluding certain regions on an image by using the mask template, so that the regions do not participate in processing or calculation of processing parameters, or only process or count the occluded regions. 3. Extract a structure feature, and detect and extract a structure feature that is in an image and that is similar to a mask by using a similarity variable or an image matching method. 4. Make a special-shape image. In the embodiments of the present disclosure, the mask template is mainly configured for extracting a region of interest. The mask template may be a two-dimensional matrix array. A row quantity of the two-dimensional matrix array is consistent with a height of the to-be-processed image (that is, a row quantity of the to-be-processed image), and a column quantity is consistent with a width of the to-be-processed image (that is, a column quantity of pixels), that is, each element in the two-dimensional matrix array is configured for processing a pixel at a corresponding position in the to-be-processed image. In the mask template, a value of an element at a position corresponding to a to-be-processed region (for example, a blurred region) of the to-be-processed image is 1, a value at another position is 0, and after the mask template of the region of interest is multiplied by the to-be-processed image, if a value at a certain position in the two-dimensional matrix array is 1, a value of a pixel at the position in the to-be-processed image remains unchanged; or if a value at a certain position in the two-dimensional matrix array is 1, a value of a pixel at the position in the to-be-processed image remains unchanged, so that the region of interest can be extracted from the to-be-processed image.

Morphological processing: is configured for extracting, from an image, image components that are significant for expressing and describing a shape of a region, so that subsequent identification can grasp the most essential shape features of a target object. Morphological processing includes but is not limited to: dilation and erosion, open operation and closed operation, morphology of a grayscale image.

The term “for example” as used below means “used as an example, embodiment or illustrative”. Any embodiment illustrated as “for example” is not to be construed as superior or better than other embodiments.

The terms such as “first” and “second” are used only for the purpose of description, and are not to be understood as indicating or implying the relative importance or implicitly specifying the quantity of the indicated technical features. Therefore, features defined by “first” and “second” may explicitly or implicitly include one or more features. In the description of the embodiments of the present disclosure, unless otherwise noted, “a plurality of” means two or more.

With development of science and technology, more and more application programs support video playback. A video played is processed. To ensure accuracy of video processing, a video inpainting technology is proposed, where video inpainting is to process a video frame image in a video.

The video inpainting technology may be implemented using a mode based on an optical flow or a mode based on a neural network model.

The mode based on an optical flow includes the following operations: Operation 1: Perform optical flow estimation by using a neighbor frame. Operation 2: Perform optical flow padding on a masked region. Operation 3: Apply an optical flow to propagate a pixel gradient of an unmasked region to the masked region. Operation 4: Perform Poisson reconstruction on the pixel gradient to generate an RGB pixel. Operation 5: If an image inpainting module is included, perform image inpainting on a region in which an optical flow cannot be padded.

However, in a case in which a background is moved simply, an optical

flow-based video inpainting method has a better inpainting effect, an image obtained after the inpainting is not blurred, and an inpainting trace is difficult to detect if a better optical flow estimation module is used. However, when a background is moved in a complex manner or an object is occluded, the inpainting effect of the optical flow-based video inpainting method is greatly affected, and an error pixel caused by an error of optical flow estimation gradually expands with propagation of the error pixel, thereby causing a content inpainting error. Referring to FIG. 1, FIG. 1 is a schematic diagram of first image processing.

In a mode based on a neural network model, a network structure is mostly an encoder-decoder structure. Both inter-frame consistency and naturality of a generated pixel need to be considered. Frame sequence information is received as an input, and an inpainted frame is directly outputted after network processing.

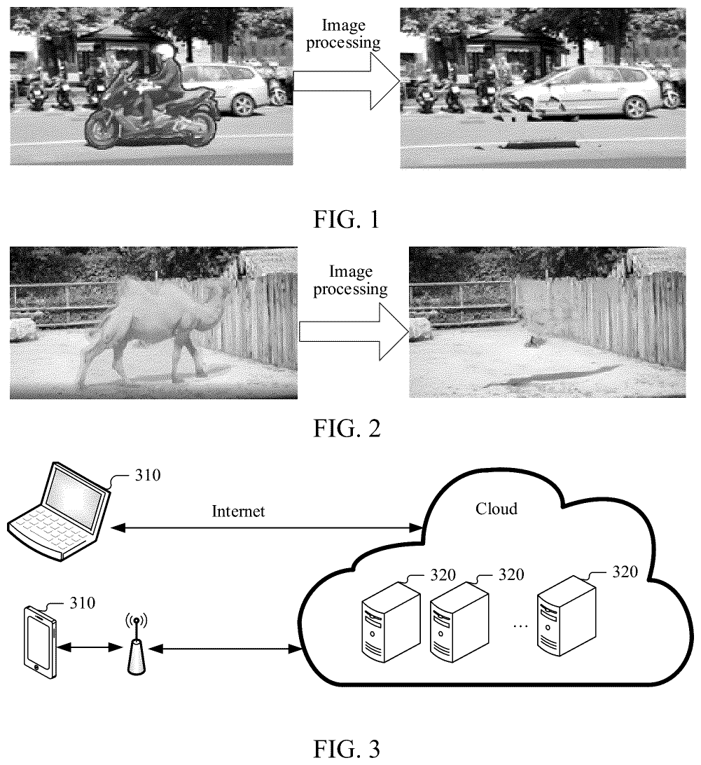

An algorithm based on a neural network model can implement inpainting with a better reference pixel propagation effect, and inpainting effect in a case of complex background movement. However, a current neural network model is a single model, and a generation capability of the single model is limited. For a case in which a texture is complex and an object is occluded, an inpainting effect may be more blurred. Limited to a video memory or the like, it is difficult to process a high-resolution input. Thus, in the case of complex textures and object occlusion, inpainting content is blurred. Referring to FIG. 2, FIG. 2 is a schematic diagram of second image processing.

It can be learned that an image processing mode in a related technology is limited by optical flow quality and model generation quality. Currently, a very robust effect cannot be implemented by using any one of the methods. Therefore, how to ensure accuracy of image processing in a case of object occlusion and complex textures, and improve image quality of a processed video frame image is a technical problem that needs to be solved currently.

In view of this, embodiments of the present disclosure provide an image

processing method and apparatus, a device, a storage medium, and a program product, so as to ensure accuracy of image processing and improve image quality of a processed video frame.

In the image processing method provided in the embodiments of the present disclosure, three types of video inpainting are completed by using a neural network model. They are respectively as follows:
1. When there is a case in which complex movement occurs in a background in a video, a video frame image is inpainted (e.g., repaired, restored, and/or filled) based on an inter-frame pixel propagation model. In this case, a first-type object may be a foreground region in a video frame.
2. When a texture of a video frame image in a video is complex, a blurred region in the video frame image is inpainted based on an image inpainting model. In this case, the first-type object may be the blurred region in the video frame. For a detection manner of the blurred region, refer to the following description.
3. For a case in which an object is occluded in a video frame image, an object region (that is, a background region occluded by a foreground object) in the video frame image is inpainted based on an object inpainting model.

In the embodiments of the present disclosure, when it is determined that another element needs to be configured for inpainting a first-type object in a video frame image, that is, when another element is configured for inpainting an image element for inpainting in the video frame image, first, mask processing is performed on a first-type object included in an obtained target video frame image to obtain a to-be-processed image after mask processing. In addition, to ensure that a second-type object that needs to be reserved in a processing process is not affected, the second-type object included in the video image is further identified to determine a corresponding object initial mask template. Then, the to-be-processed image and the object initial mask template are inputted into a trained information propagation model, and inpainting processing is performed on the first-type object in the to-be-processed image by using the information propagation model to obtain a first inpainting image. In this case, inpainting is completed for an image element for inpainting, an initial blurred region in the first inpainting image (the initial blurred region is a blurred region that still exists in the obtained first inpainting image after the to-be-processed image is inpainted) is detected, a corresponding image initial mask template is generated based on the initial blurred region, and an object target mask template in the to-be-processed image is determined.

To ensure accuracy of image processing in an image inpainting process, after the first inpainting image is obtained, in the embodiments of the present disclosure, the initial blurred region in the first inpainting image is further detected, and a corresponding image initial mask template is generated. When it is determined that a first quantity of initial blurred pixels included in the image initial mask template reaches a first threshold, morphological processing is performed on an initial blurred region corresponding to the initial blurred pixel, to obtain an image target mask template, so that the blurred region is more regular. Then, a second quantity of intermediate blurred pixels included in the image target mask template is determined. When the second quantity reaches a second threshold, in the first inpainting image, inpainting processing is performed on a pixel region corresponding to the intermediate blurred pixel by using an image inpainting model to obtain a second inpainting image, and inpainting processing is performed on the blurred region in the first inpainting image, that is, the blurred region in the first inpainting image is enhanced. Finally, when it is determined that the contour of the second-type object in the object initial mask template is inconsistent with the contour of the second-type object in the object target mask template, in the second inpainting image, inpainting processing is performed on a pixel region corresponding to the second-type object in the second inpainting image by using an object inpainting model to obtain a third inpainting image, so that inpainting processing is performed on a occluded object region, that is, the blurred region in the second inpainting image is enhanced.

The initial blurred pixel refers to a pixel in the image initial mask template, and the intermediate blurred pixel refers to a pixel in the image target mask template.

In the embodiments of the present disclosure, inpainting processing is performed on a blurred region with blurred inpainting caused by a complex texture and an object occlusion condition, and enhancement processing is performed on the blurred region, thereby improving image quality of a target inpainting image.

In the embodiments of the present disclosure, an information propagation model, an image inpainting model, and a part of an object inpainting model relate to artificial intelligence (AI) and a machine learning technology, and are implemented based on a voice technology, a natural language processing technology, and machine learning (ML) in AI.

AI involves a theory, a method, a technology, and an application system that use a digital computer or a machine controlled by the digital computer to simulate, extend, and expand human intelligence, perceive an environment, obtain knowledge, and use knowledge to obtain an optimal result. In other words, AI is a comprehensive technology in computer science and attempts to understand the essence of intelligence and produce a new intelligent machine that can react in a manner similar to human intelligence.

AI is to study the principles and implementation methods of various intelligent machines, to enable the machines to have the functions of perception, reasoning, and decision-making. AI technologies mainly include several major directions such as a computer vision technology, a nature language processing technology, and machine learning/deep learning. With research and progress of AI technologies, AI is studied and applied in a plurality of fields, such as common smart home, intelligent customer service, virtual assistant, intelligent sound boxes, intelligent marketing, unmanned driving, autonomous driving, robots, and intelligent medical treatment. It is believed that with development of technologies, AI will be applied in more fields and play an increasingly important role.

Machine learning (ML) is a multi-field interdiscipline, and relates to a plurality of disciplines such as the probability theory, statistics, the approximation theory, convex analysis, and the algorithm complexity theory. ML specializes in studying how a computer simulates or implements a human learning behavior to obtain new knowledge or skills, and reorganize an existing knowledge structure, so as to keep improving its performance. In contrast to data mining, which looks for mutual characteristics among big data, machine learning focuses more on the design of algorithms that allow computers to automatically “learn” patterns from data and use them to make predictions about unknown data.

ML is the core of AI, is a basic way to make the computer intelligent, and is applied to various fields of AI. ML and deep learning generally include technologies such as an artificial neural network, a belief network, reinforcement learning, transfer learning, and inductive learning. Reinforcement learning (RL), also referred to as evaluation learning, is one of paradigms and methodologies of machine learning for describing and solving a problem that agents maximize rewards or achieve a specific goal by learning strategies during their interaction with the environment.

The following describes preferred embodiments of the present disclosure with reference to the accompanying drawings of this specification. The preferred embodiments described herein are merely configured for describing and explaining the present disclosure, and are not configured for limiting the present disclosure. In addition, in a case of no conflict, features in the embodiments and the embodiments of the present disclosure may be mutually combined.

Referring to FIG. 3, FIG. 3 is a schematic diagram of an application scenario according to an embodiment of the present disclosure. The application scenario includes a terminal device 310 and a server 320. The terminal device 310 and the server 320 may communicate with each other by using a communication network.

In one embodiment, the communication network may be a wired network or a wireless network. Therefore, the terminal device 310 and the server 320 may be directly or indirectly connected in a wired or wireless communication manner. For example, the terminal device 310 may be indirectly connected to the server 320 by using a wireless access point, or the terminal device 310 is directly connected to the server 320 by using the Internet, which is not limited in the present disclosure.

In this embodiment of the present disclosure, the terminal device 310 includes but is not limited to a device such as a mobile phone, a tablet computer, a notebook computer, a desktop computer, an e-book reader, an intelligent voice interaction device, a smart home appliance, and an in-vehicle terminal. Various clients may be installed on the terminal device. The client may be an application program (such as a browser or game software) that supports functions such as video editing and video playback, or may be a web page or a mini program.

The server 320 is a background server corresponding to a client installed in the terminal device 310. The server 320 may be an independent physical server, or may be a server cluster or a distributed system formed by multiple physical servers, or may be a cloud server that provides basic cloud computing service such as a cloud service, a cloud database, cloud computing, a cloud function, cloud storage, a network service, cloud communication, a middleware service, a domain name service, a security service, a content delivery network (CDN), big data, and an artificial intelligence platform.

The image processing method in this embodiment of the present disclosure may be performed by an electronic device. The electronic device may be the server 320 or the terminal device 310. That is, the method may be independently performed by the server 320 or the terminal device 310, or may be jointly performed by the server 320 and the terminal device 310.

When the method is independently performed by the terminal device 310, for example, the terminal device 310 may obtain a to-be-processed image after mask processing, perform inpainting processing on the to-be-processed image to obtain a first inpainting image, determine an image initial mask template corresponding to the first inpainting image, process the image initial mask template when a first quantity of initial blurred pixels included in the image initial mask template reaches a first threshold, obtain an image target mask template, and continue inpainting processing on a blurred position in the first inpainting image when a second quantity of intermediate blurred pixels included in the image target mask template reaches a second threshold, to obtain a second inpainting image, and finally determine a target inpainting image corresponding to the to-be-processed image based on the second inpainting image.

When the method is independently performed by the server 320, for example, the terminal device 310 may obtain a video frame image, and then send the video frame image to the server 320. The server 320 performs mask processing on a first-type object included in the obtained video frame image, to obtain a to-be-processed image after mask processing, performs inpainting processing on the to-be-processed image, to obtain a first inpainting image, determines an image initial mask template corresponding to the first inpainting image, when a first quantity of initial blurred pixels included in the image initial mask template reaches a first threshold, processes the image initial mask template to obtain an image target mask template, when a second quantity of intermediate blurred pixels in the image target mask template reaches a second threshold, continues to perform inpainting processing on a blurred position in the first inpainting image to obtain a second inpainting image, and finally determines a target inpainting image corresponding to the to-be-processed image based on the second inpainting image.

When the method is jointly performed by the server 320 and the terminal device

310, for example, the terminal device 310 may obtain a to-be-processed image, perform inpainting processing on the to-be-processed image to obtain a first inpainting image, and then send the first inpainting image to the server 320. The server 320 determines an image initial mask template corresponding to the first inpainting image, when a first quantity of initial blurred pixels included in the image initial mask template reaches a first threshold, processes the image initial mask template to obtain an image target mask template, when a second quantity of intermediate blurred pixels included in the image target mask template reaches a second threshold, continues to perform inpainting processing on a blurred position in the first inpainting image to obtain a second inpainting image, and finally determines a target inpainting image corresponding to the to-be-processed image based on the second inpainting image.

In the following, an example in which the server independently performs the method is mainly configured for description. This is not specifically limited herein.

During specific implementation, a video frame image may be inputted into the terminal device 310. The terminal device 310 sends a to-be-processed video frame image to the server 320. The server 320 may determine a target inpainting image corresponding to the to-be-processed image by using the image processing method in this embodiment of the present disclosure.

FIG. 3 shows only an example for description. Actually, a quantity of terminal devices 310 and a quantity of servers 320 are not limited, and are not specifically limited in this embodiment of the present disclosure.

In this embodiment of the present disclosure, when there are a plurality of servers 320, the plurality of servers 320 may form a blockchain, and the servers 320 are nodes on the blockchain. According to the image processing method disclosed in this embodiment of the present disclosure, an inpainting processing mode and a morphology processing mode involved may be stored in the blockchain.

The following describes, with reference to the foregoing described application scenario, the image processing method provided in the exemplary implementation of the present disclosure according to the accompanying drawings. The foregoing application scenario is merely shown for ease of understanding the spirit and principle of the present disclosure, and the implementation of the present disclosure is not limited in this aspect.

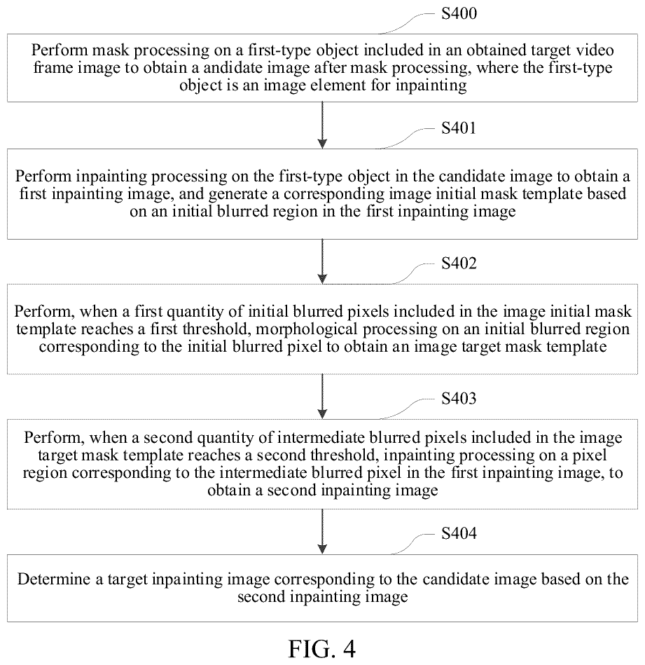

Referring to FIG. 4, FIG. 4 is a flowchart of an image processing method according to an embodiment of the present disclosure, and the method includes the following operations:

Operation S400: Perform mask processing on a first-type object included in an obtained target video frame image, to obtain a to-be-processed image (also referred as candidate image) after mask processing; the first-type object being an image element for inpainting.

During video inpainting processing, a video sequence x={xₜ} (t=0, 1, 2, . . . , T) on which video inpainting needs to be performed and a corresponding mask template sequence m={mₜ} (t=0, 1, 2, . . . , T) are first obtained, where xₜ indicates a video frame image on which video inpainting needs to be performed, that is, a video frame image before processing, and mₜ indicates a mask template corresponding to the video frame image. The mask template is configured for indicating an image element for inpainting, that is, a mask region corresponding to the first-type object may be determined by using the mask template.

Then, mask processing is performed on the corresponding video frame image based on the mask region in the mask template, to obtain a to-be-processed image xₘₜ after mask processing. Mask processing is xₘₜ=xₜ·(1−mₜ), where the mask template mₜ is generally a binary matrix, and “·” is multiplication element by element. Therefore, the to-be-processed image includes an inpainting region that is determined based on the mask region and that requires video inpainting. The mask region is an inpainting region.

Image processing mainly includes performing inpainting processing on the inpainting region of the to-be-processed image, that is, performing inpainting processing on the mask region in the video frame image xₜ to obtain a processed video sequence y={yₜ} (t=0, 1, 2, . . . , T), where yₜ indicates the video frame image after inpainting processing.

To ensure that only image content in the mask region is different in the video frame image yₜ obtained after inpainting processing compared with the video frame image xₜ before inpainting processing, image content in another region is natural and consistent in time and space. In this embodiment of the present disclosure, first, inpainting processing is performed on an inpainting region in a to-be-processed image to obtain a first inpainting image. Then, detection is performed on the first inpainting image, so as to determine whether image content of another region in the first inpainting image is the same as image content of a video frame image before inpainting processing or a to-be-processed image before inpainting processing, and determine whether a first padding image needs to be further padded, so as to obtain a target padding image whose image content in another region is the same as that of the video frame image before inpainting processing or the to-be-processed image before inpainting processing except the inpainting region.

Operation S401: Perform inpainting processing on the first-type object in the to-be-processed image to obtain a first inpainting image, and generate a corresponding image initial mask template based on an initial blurred region in the first inpainting image.

The generating a corresponding image initial mask template based on an initial blurred region in the first inpainting image includes: generating the image initial mask template that includes the initial blurred region. That is, the image initial mask template is a mask template of the initial blurred region. The image initial template may be a two-dimensional matrix array, a row quantity of the two-dimensional matrix array is consistent with a height of the first inpainting image (that is, a row quantity of the first inpainting image), a column quantity is consistent with a width of the first inpainting image (that is, a column quantity of pixels of the first inpainting image), and each element in the two-dimensional matrix array is configured for processing a pixel at a corresponding position in the first inpainting image. A value of an element that is in the image initial mask template and that is at a position corresponding to the initial blurred region of the to-be-processed image is 1, and a value of another position is 0. After the image initial mask template is multiplied by the first inpainting image, if a value of a position in the two-dimensional matrix array is 1, a value of a pixel in the position of the first inpainting image remains unchanged; or if a value of a position in the two-dimensional matrix array is 1, a value of a pixel in the position of the first inpainting image remains unchanged, so that the image initial mask template may be configured for extracting the initial blurred region from the first inpainting image.

In one embodiment, first, a video sequence xₘ={xₘₜ} (t=0, 1, 2, . . . , T) that includes the to-be-processed image is inputted to a trained information propagation model F_{T}. Then, inpainting processing is performed on the first-type object in the to-be-processed image by using the trained information propagation model F_{T}, to obtain the first inpainting image x_{tcomp}_{ₜ}, and the corresponding image initial mask template m_{blur} is generated based on the initial blurred region in the first inpainting image. Finally, the first inpainting image x_{tcomp}_{ₜ} and the image initial mask template m_{blur} are outputted by using the trained information propagation model F_{T}, where the image initial mask template m_{blur} indicates a region in the first inpainting image that has a poor inpainting effect, that is, a blurred region in the first inpainting image.

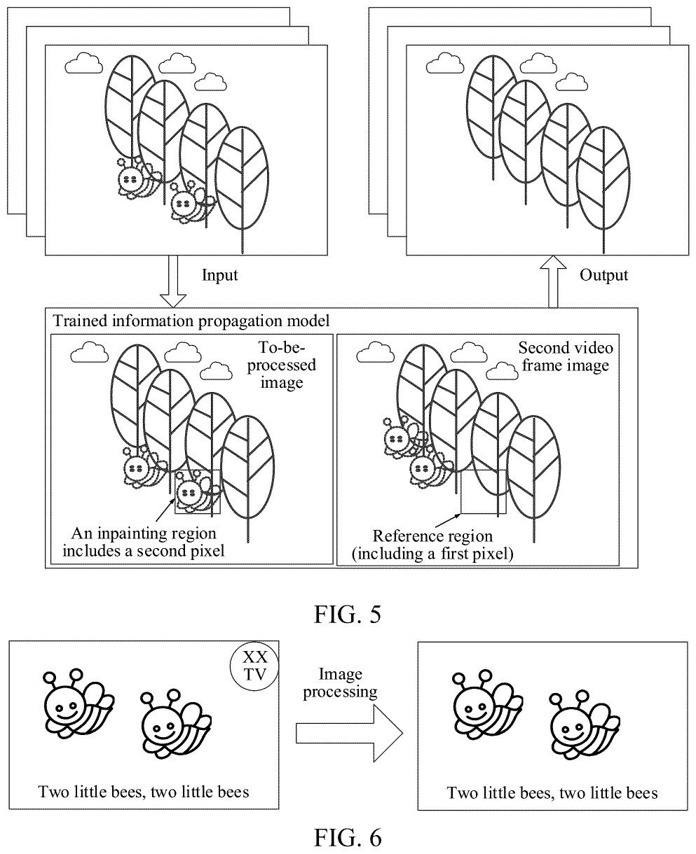

When padding processing is performed on the first-type object in the to-be-processed image by using the trained information propagation model F_{T}, first, a video sequence containing the to-be-processed image is inputted into the trained information propagation model F_{T}. Then, in the trained information propagation model F_{T}, inpainting processing is performed on the first-type object in the to-be-processed image based on pixels in another video frame image included in the video sequence by referring to time domain information and space domain information. Specifically, in adjacent two or more video frame images that include the to-be-processed image, a first pixel in another video frame image is configured for padding a second pixel in the to-be-processed image, where a position of the first pixel in the another video frame is the same as a position of the second pixel in the to-be-processed image in the video frame image. Referring to FIG. 5, FIG. 5 is a schematic diagram of performing padding processing on a first-type object according to an embodiment of the present disclosure.

The generating a corresponding image initial mask template m_{blur} based on an initial blurred region in the first inpainting image may be implemented in the following manner:

First, the first inpainting image is divided into a plurality of pixel blocks according to a size of the first inpainting image. For example, the size of the first inpainting image is 7 cm*7 cm, and a size of each pixel block may be 0.7 cm*0.7 cm. A mode of dividing the first inpainting image into a plurality of pixel blocks is merely an example for description, and is not the only mode.

Then, a resolution of each pixel block is determined, a pixel block is determined based on the resolution of each pixel block in the first padding image, and the pixel block is used as an initial blurred region. Specifically, because a higher resolution leads to a clearer image and better image quality, in this embodiment of the present disclosure, image quality may be set to a resolution threshold. When a resolution of a pixel block is less than the resolution threshold, the pixel block is used as an initial blurred region.

Finally, mask processing is performed on the initial blurred region based on the initial blurred region to obtain a corresponding image initial mask template m_{blur}.

In this embodiment of the present disclosure, the first-type object includes but is not limited to: logo removal, subtitle removal, object removal, and the like. The object may be a moving person or object, or may be a still person or object.

For example, a video segment is created based on a video of a website of a platform. However, because a video obtained from the platform carries a logo, a sense of appearance is affected. In this case, a first-type object is a logo, and the logo may be removed from a video frame image of the video by using the image processing technology provided in this embodiment of the present disclosure. Referring to FIG. 6, FIG. 6 is a schematic diagram of image processing according to an embodiment of the present disclosure.

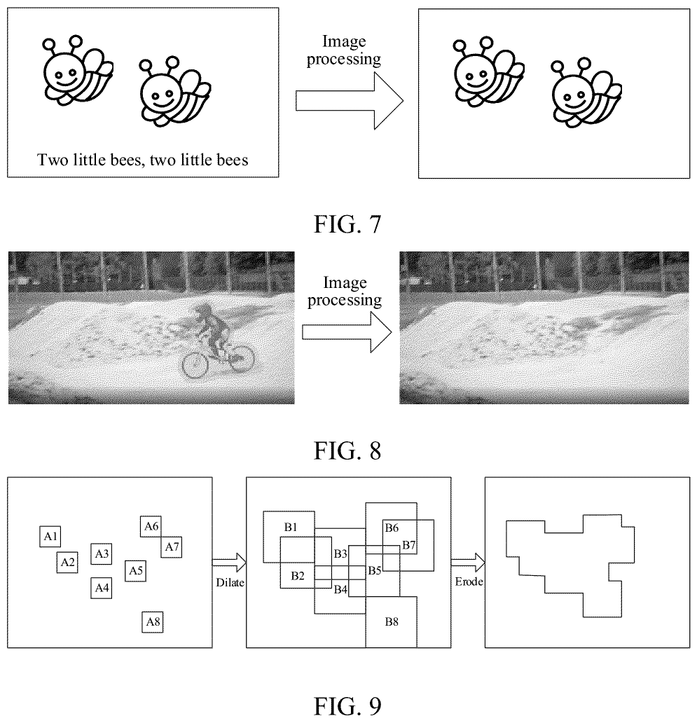

Similarly, a subtitle may be removed from a video frame image. Referring to FIG. 7, FIG. 7 is a schematic diagram of image processing according to an embodiment of the present disclosure. Alternatively, some moving objects, such as a passerby and a vehicle, are removed from a video frame image. Referring to FIG. 8, FIG. 8 is a schematic diagram of image processing according to an embodiment of the present disclosure.

Operation S402: Perform, when a first quantity of initial blurred pixels included in the image initial mask template reaches a first threshold, morphological processing on an initial blurred region corresponding to the initial blurred pixel to obtain an image target mask template.

The image initial mask template is determined based on a pixel block, and each pixel block has a resolution corresponding to the pixel block, where the resolution represents a quantity of pixels of the pixel block in a horizontal direction and a vertical direction. Therefore, based on the resolution of each pixel block, a quantity of pixels included in the pixel block is determined, and the first quantity of the initial blurred pixels included in the image initial mask template is obtained by adding quantities of pixels included in all the pixel blocks included in the image initial mask template.

Specifically, a quantity of pixels in a pixel block=a quantity of pixels in a horizontal direction * a quantity of pixels in a vertical direction.

In one embodiment, when the first quantity of the initial blurred pixels included in the image initial mask template reaches the first threshold, there are a large quantity of pixel blocks in the first inpainting image.

However, when the pixel blocks in the first inpainting image are relatively scattered, that is, the initial blurred regions are not concentrated, even in a case in which there are a large quantity of pixel blocks in the first inpainting image, a blurred region with a blurred image cannot be clearly displayed in the first inpainting image. In this case, it is determined that an inpainting effect of the first inpainting image is up to standard, and no inpainting processing needs to be performed on the first inpainting image, thereby reducing a calculation amount.

Therefore, to ensure accuracy of image inpainting and reduce a calculation amount, it is necessary to verify the first inpainting image to determine whether the inpainting effect of the first inpainting image is up to standard. On this basis, in this embodiment of the present disclosure, in the image initial mask template, morphological processing is performed on the initial blurred region corresponding to the initial blurred pixel to obtain an image target mask template, so that the initial blurred regions in the first inpainting image are connected, and the blurred region is more regular.

In one embodiment, in the image initial mask template, morphological

processing is performed on the initial blurred region corresponding to the initial blurred pixel to obtain an image target mask template, which may be implemented in the following manner: performing, by using dilation f_{dilate} operation and an erosion f_{erode} operation, an operation of dilating a plurality of initial blurred regions m_{blur} before etching, so that the plurality of scattered initial blurred regions are connected, and obtain an image target mask template, where the image target mask template is \tilde{m}_{blur}=f_{erode}(f_{dilate}(m_{blur})).

Referring to FIG. 9, FIG. 9 is a schematic diagram of performing morphological processing on an initial blurred region according to an embodiment of the present disclosure. It is assumed that a first inpainting image includes a plurality of initial blurred regions, which are respectively A1 to A8. In this case, the initial blurred regions A1 to A8 are first dilated according to a set dilation ratio to obtain dilated initial blurred regions B1 to B8, for example, the initial blurred regions A1 to A8 are dilated by 10 times. Then, whether overlapping exists in the dilated initial blurred regions B1 to B8 is determined, and overlapping regions are combined to obtain at least one combined region. Finally, the combined region is etched according to a shrinkage ratio to obtain an intermediate blurred region, where the shrinkage ratio is determined based on the dilation ratio, and when the dilation ratio is 10, the shrinkage ratio is 1/10.

The principle of image erosion is as follows: It is assumed that a foreground object in an image is 1, and a background is 0. It is assumed that there is one foreground object in the original image, and a process of etching the original image by using a structural element is as follows: Pixels of the original image are traversed, then a pixel currently being traversed is aligned with a center point of the structural element, then a minimum value of all pixels in a region corresponding to the original image covered by the current structural element is taken, and the current pixel value is replaced with the minimum value. Because the minimum value of the binary image is 0, 0 is configured for replacement, that is, the image changes to a black background. Therefore, it can also be seen that, if what the current structure element covers is only the background, the original image is not changed because the whole of the background is 0, and if what the current structure element covers is foreground pixels, the original image is not changed because all of the foreground pixels are 1. Only when the structural element is located at the edge of the foreground object, two different pixel values 0 and 1 will appear in the region covered by the structural element. In this case, the current pixel will be replaced with 0 and a change occurs. Therefore, erosion appears to have the effect of reducing the foreground object by one circle. For some small connections in the foreground object, if sizes of structural elements are equal, these connections will be disconnected.

In this case, the scattered initial blurred regions are connected to generate an intermediate blurred region, and each intermediate blurred region is equal to or greater than the initial blurred region compared with the initial blurred region. When the intermediate blurred region is relatively large (for example, the width and height are greater than corresponding width and height thresholds), a blurred region with a blurred image can be clearly displayed in the first inpainting image. In this case, the inpainting effect of the first inpainting image is poor, and inpainting processing needs to be performed on the first inpainting image. Therefore, whether to perform inpainting processing on the first inpainting image is determined based on the image target mask template, and a calculation amount is reduced while an inpainting effect is ensured.

In another embodiment, when the first quantity of the initial blurred pixels included in the image initial mask template is less than the first threshold, pixel blocks in the first inpainting image are reduced, and a blurred region with a blurred image cannot be clearly displayed in the first inpainting image. In this case, it is determined that the inpainting effect of the first inpainting image is better, and the first inpainting image is used as a target inpainting image corresponding to the to-be-processed image, so that no operation such as morphological processing needs to be performed on the blurred region corresponding to the initial blurred pixel, and no operation such as continuing processing needs to be performed on the first inpainting image, thereby reducing a calculation procedure and improving image processing efficiency.

Operation S403: Perform, when a second quantity of intermediate blurred pixels included in the image target mask template reaches a second threshold, inpainting processing on a pixel region corresponding to the intermediate blurred pixel in the first inpainting image, to obtain a second inpainting image.

Because the scattered initial blurred regions are connected in the image target mask template, when the second quantity of the intermediate blurred pixels included in the image target mask template reaches the second threshold, a blurred region with a blurred image can be clearly displayed in the first inpainting image, and the inpainting effect of the first inpainting image is not good. In this case, to ensure accuracy of image processing, the pixel region corresponding to the intermediate blurred pixel in the first inpainting image needs to be inpainted.

In one embodiment, in the first inpainting image, inpainting processing is performed on the pixel region corresponding to the intermediate blurred pixel, which may be implemented in the following manner:

First, the first inpainting image and the image target mask template are inputted into a trained image inpainting model F_{I}.

Then, in the trained image inpainting model F_{I}, in the first inpainting image x_{tcomp}_{ₜ}, inpainting processing is performed on the pixel region corresponding to the intermediate blurred pixel based on the image target mask template \tilde{m}_{blur} to obtain a second inpainting image. An inpainting processing process of the trained image inpainting model is denoted as follows:

$${x}_{b l u r c o m p} = {F}_{I} ( {x}_{tcomp} , {\tilde{m}}_{b l u r} )$$

x_{blurcomp} indicates the second inpainting image.

The pixel region is determined in the following manner: determining a region at the same position in the first inpainting image as the pixel region according to the position of the intermediate blurred pixel in the target mask template. The pixel region corresponding to then intermediate blurred pixel is generally a reference-free region or a moving-object region.

In this embodiment of the present disclosure, the trained image inpainting model F_{I} may be an image generation tool configured for a blurred region, such as a latent diffusion model (LDM) or large mask inpainting (LaMa).

The LDM model is a high-resolution image synthesis training tool. In image inpainting and various tasks (for example, unconditional image generation, semantic scene synthesis, and super-resolution), high contention performance is achieved.

The LaMa model is an image generation tool, and can be well generalized to a higher resolution image.

The following describes, by using the LaMa model as an example, inpainting processing on the pixel region corresponding to the intermediate blurred pixel in the first inpainting image.

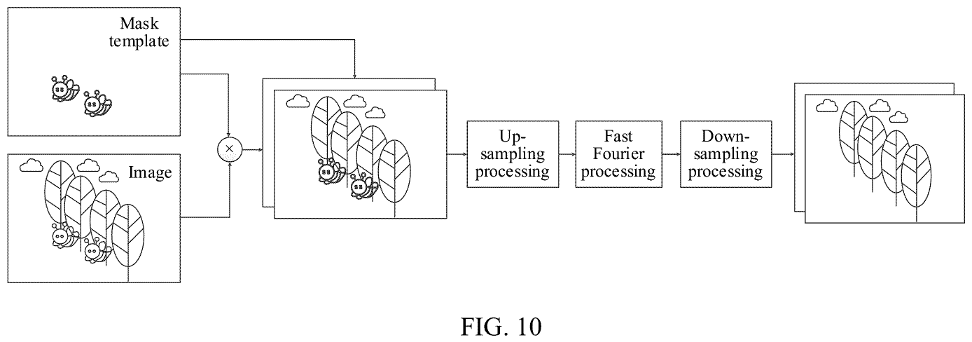

In the first inpainting image, by using the LaMa model, inpainting processing is performed on the pixel region corresponding to the intermediate blurred pixel, which may be implemented in the following manner: First, the first inpainting image with three channels and the image target mask template with one channel are inputted into the LaMa model. Second, in the LaMa model, the image target mask template is negated, and is multiplied by the first inpainting image to obtain a first color image with a mask region. Then, the first color picture and the image template mask template are superposed to obtain a 4-channel image. Then, after a down-sampling operation is performed on the 4-channel image, fast Fourier convolution (FFC) processing is performed, and up-sampling processing is performed on the image obtained after FFC processing to obtain the second inpainting image. In the FFC processing process, the inputted image is divided into two parts based on channels, and the two parts pass through two different branches. One branch is responsible for extracting local information, referred to as a local branch. The other branch is responsible for extracting global information, referred to as a global branch. FFC is used in the global branch to extract a global feature. Finally, the local information and the global information are cross-fused, and then spliced based on channels to obtain a final second inpainting image. Referring to FIG. 10, FIG. 10 is a schematic diagram of performing inpainting processing on a pixel region corresponding to an intermediate blurred pixel according to an embodiment of the present disclosure.

In this embodiment of the present disclosure, FFC enables the LaMa model to obtain a receptive field of an entire image even at a shallow layer. FFC not only improves inpainting quality of the LaMa model, but also reduces a parameter quantity of the LaMa model. In addition, an offset in FFC enables better generalization of the LaMa model. A low resolution image may be configured for generating an inpainting result of a high resolution image. FFC can work in both the spatial domain and the frequency domain, and a context of the image can be understood without returning to the previous layer.

The first threshold and the second threshold may be the same or different. A manner of determining the second quantity of the intermediate blurred pixels is similar to a manner of determining the first quantity of the initial blurred pixels, and details are not described herein again.

In another embodiment, when the second quantity of the intermediate blurred pixels included in the image target mask template is less than the second threshold, pixel blocks in the first inpainting image are reduced, a blurred region with a blurred image cannot be clearly displayed in the first inpainting image, and the inpainting effect of the first inpainting image is better. In this case, the first inpainting image is used as the target inpainting image corresponding to the to-be-processed image, and inpainting processing does not need to be performed on the blurred region in the first inpainting image, so as to reduce a calculation procedure and improve image processing efficiency.

Operation S404: Determine a target inpainting image corresponding to the to-be-processed image based on the second inpainting image.

In this embodiment of the present disclosure, inpainting processing is performed on the first-type object in the to-be-processed image to obtain the first inpainting image. After inpainting of an image element for inpainting is completed, to ensure accuracy of image processing in an image inpainting process, the initial blurred region in the first inpainting image is further detected, and the corresponding image initial mask template is generated. When it is determined that the first quantity of the initial blurred pixels included in the image initial mask template reaches the first threshold, morphological processing is performed on the blurred region corresponding to the initial blurred pixel to obtain the image target mask template, so that scattered initial blurred regions are connected, and the blurred region is more regular. Then, when it is determined that the second quantity of the intermediate blurred pixels included in the image target mask template reaches the second threshold, in the first inpainting image, inpainting processing is performed on the pixel region corresponding to the intermediate blurred pixel to obtain the second inpainting image. Finally, the target inpainting image corresponding to the to-be-processed image is determined based on the second inpainting image. Performing inpainting processing on the blurred region in the first inpainting image is performing enhancement processing on the blurred region in the first inpainting image. In addition, enhancement processing is performed on the blurred region in the first inpainting image, so as to obtain the second inpainting image, thereby improving image quality of the second inpainting image, and further ensuring image quality of the target inpainting image.

In the foregoing operation S404, when the target inpainting image corresponding to the to-be-processed image is determined based on the second inpainting image, the second inpainting image may be used as the target inpainting image, or a third inpainting image obtained after inpainting processing is performed on the second inpainting image is used as the target inpainting image.

Specifically, whether the second inpainting image is used as the target inpainting image or the third padding image is used as the target inpainting image is determined based on whether a contour of a second-type object in the object initial mask template is consistent with a contour of a second-type object in an object target mask template.

The object target mask template is determined in the following manner:

First, an object initial mask template m_{obj} is inputted into the trained information propagation model F_{T}. Then, in the trained information propagation model F_{T}, object contour complementation processing is performed on a second-type object in the object initial mask template based on an object complementation capability of the trained information propagation model F_{T}, to obtain an object target mask template m_{obj}_{_{comp}}. The object initial mask template is determined after the second-type object included in the video frame image is identified, and the second-type object is an image element that needs to be reserved.

In one embodiment, the object initial mask template m_{obj} corresponding to the second-type object in the video frame image is determined by using a visual identity system (VIS) F_{VIS}. A process of determining the object initial mask template m_{obj} by using the visual identity model F_{VIS} is as follows:

$${m}_{o b j} = {F}_{VIS} ( {x}_{m} )$$

where, xₘ is a video frame image.

In another embodiment, the object initial mask template m_{obj} corresponding to the second-type object in the to-be-processed image is determined by using a visual identity model F_{VIS}.

The visual identity model is obtained by training an image on which a mask template exists.

In this embodiment of the present disclosure, the object initial mask template is first compared with the object target mask template to obtain a first comparison result, the first comparison result being configured for indicating whether contours of the second-type objects are consistent. Then, based on the first comparison result, the second inpainting image is processed to obtain the target inpainting image.

When the object initial mask template and the object target mask template are compared, the object initial mask template and the object target mask template may be completely overlapped to determine whether the mask region of the second-type object in the object initial mask template completely overlaps the mask region of the second-type object in the target mask template. If the mask region of the second-type object in the object initial mask template completely overlaps the mask region of the second-type object in the target mask template, it is determined that the first comparison result is configured for representing that the contours of the second-type objects are consistent; otherwise, it is determined that the first comparison result is configured for representing that the contours of the second-type objects are inconsistent.

When the object initial mask template is compared with the object target mask template, a third pixel quantity of the mask regions of the second-type objects in the object initial mask template and a fourth pixel quantity of the mask regions of the second-type objects in the object target mask template are determined, and the first comparison result is determined based on a difference between the third pixel quantity and the fourth pixel quantity, where the difference between the third pixel quantity and the fourth pixel quantity represents a difference between the mask regions of the second-type objects in the object initial mask template and the object target mask template.

When the comparison result is determined based on the difference between the third pixel quantity and the fourth pixel quantity, if the difference between the third pixel quantity and the fourth pixel quantity is less than a threshold, it is determined that the first comparison result is configured for representing that the contours of the second-type objects are consistent; otherwise, it is determined that the first comparison result is configured for representing that the contours of the second-type objects are inconsistent.

In one embodiment, when the first comparison result indicates that the contours of the second-type objects are consistent, the second inpainting image is used as the target inpainting image.

In another embodiment, when the first comparison result indicates that the contours of the second-type objects are inconsistent, the second inpainting image is processed to obtain the target inpainting image, which may be implemented in the following manner:

First, the second inpainting image and the object target mask template are inputted into the trained object inpainting model F_{obj}.

Then, in the trained object inpainting model F_{obj}, in the second inpainting image x_{blurcomp}, inpainting processing is performed on the pixel region corresponding to the second-type object based on the object target mask template m_{obj}_{_{comp}}, to obtain a third inpainting image, and the third inpainting image is used as the target inpainting image. An inpainting processing process of the trained object inpainting model F_{obj} is denoted as follows:

$${x}_{objcomp} = {F}_{obj} ( {x}_{objremain} , {m}_{obj} )$$

where, x_{objcomp} represents an inpainted third inpainting image, x_{objremain} represents a visible pixel part of the to-be-processed image, and x_{objremain}=xₘₜ·m_{obj}, that is, a color image including a mask region of a first-type object and a mask region of a second-type object.

In this embodiment of the present disclosure, the trained object inpainting model may use any model configured for image inpainting, for example, spatial-temporal transformations for video inpainting (STTN) configured for video inpainting. When inpainting processing is performed on the pixel region corresponding to the second-type object in the first inpainting image by using the object inpainting model, inpainting processing is performed on the pixel region corresponding to the second-type object by using a visible pixel part based on a self-attention feature of the transformations.

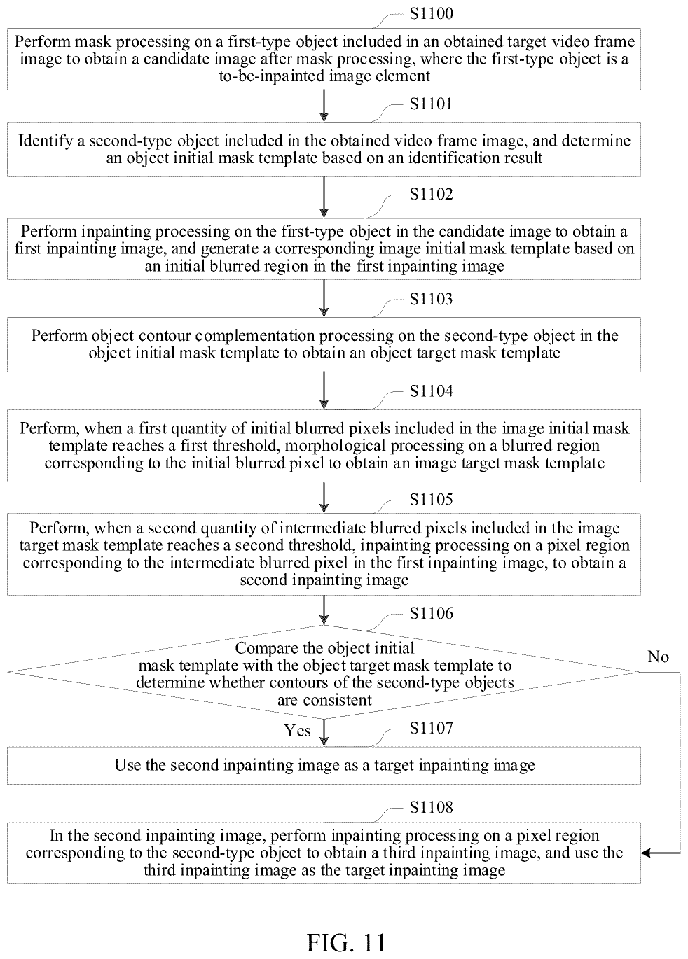

Referring to FIG. 11, FIG. 11 is a flowchart of another image processing method according to an embodiment of the present disclosure, and the method includes the following operations:
Operation S1100: Perform mask processing on a first-type object included in an obtained target video frame image, to obtain a to-be-processed image after mask processing; the first-type object being an image element for inpainting.
Operation S1101: Identify a second-type object included in the obtained video frame image, and determine an object initial mask template based on an identification result.
Operation S1102: Perform inpainting processing on the first-type object in the to-be-processed image to obtain a first inpainting image, and generating a corresponding image initial mask template based on an initial blurred region in the first inpainting image.
Operation S1103: Perform object contour complementation processing on the second-type object in the object initial mask template to obtain an object target mask template.
Operation S1104: Perform, when a first quantity of initial blurred pixels included in the image initial mask template reaches a first threshold, morphological processing on a blurred region corresponding to the initial blurred pixel to obtain an image target mask template.
Operation S1105: Perform, when a second quantity of intermediate blurred pixels included in the image target mask template reaches a second threshold, inpainting processing on a pixel region corresponding to the intermediate blurred pixel in the first inpainting image, to obtain a second inpainting image.
Operation S1106: Compare the object initial mask template with the object target mask template to determine whether contours of the second-type objects are consistent, and if yes, perform operation S1107; otherwise, perform operation S1108.
Operation S1107: Use the second inpainting image as a target inpainting image.
Operation S1108: In the second inpainting image, perform inpainting

processing on a pixel region corresponding to the second-type object to obtain a third inpainting image, and use the third inpainting image as the target inpainting image.

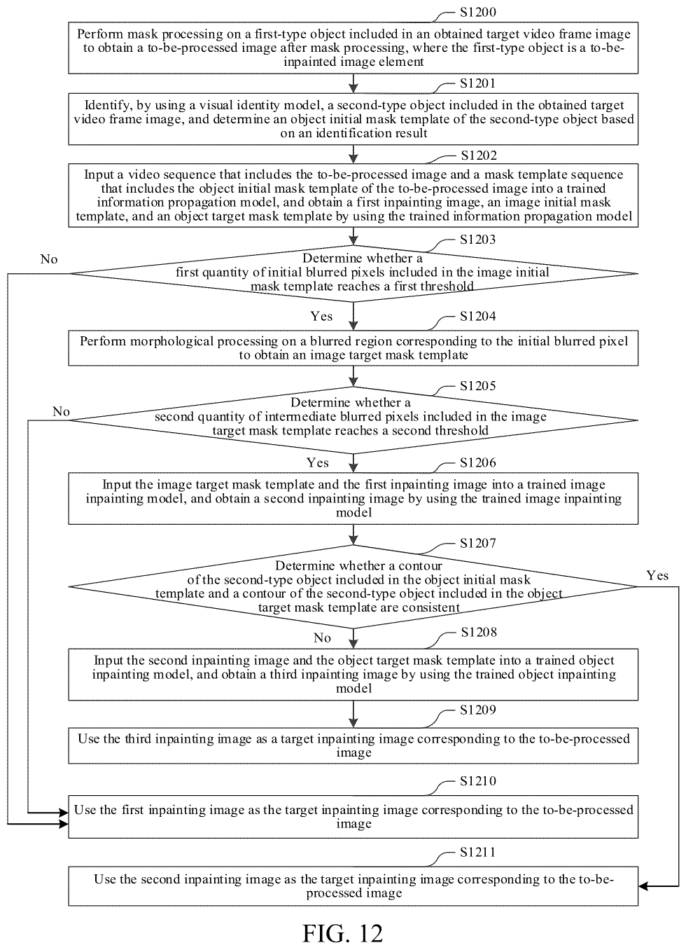

Referring to FIG. 12, FIG. 12 exemplarily provides a flowchart of a specific implementation method for image processing according to an embodiment of the present disclosure, including the following operations:
Operation S1200: Perform mask processing on a first-type object included in an obtained target video frame image to obtain a to-be-processed image after mask processing, where the first-type object is an image element for inpainting.
Operation S1201: Identify, by using a visual identity model, a second-type object included in the obtained target video frame image, and determine an object initial mask template of the second-type object based on an identification result.
Operation S1202: Input a video sequence that includes the to-be-processed image and a mask template sequence that includes the object initial mask template of the to-be-processed image into a trained information propagation model, and obtain a first inpainting image, an image initial mask template, and an object target mask template by using the trained information propagation model.

That is, two input parameters corresponding to the trained information propagation model are respectively:
a first input parameter:

$${x}_{m} = \{ {x}_{mt} \} ( t = 0 , 1 , 2 , … , T ) , where {x}_{mt} = {x}_{t} \cdot ( 1 - {m}_{t} ) ;$$

the first input parameter is the video sequence that includes the to-be-processed image, and each frame of image in the video sequence may be a to-be-processed image xₘₜ;
a second input parameter:

$${m}_{obj} = {F}_{VIS} ( {x}_{m} ) , where {m}_{obj} = \{ {m}_{{obj}_{1}} , {m}_{{obj}_{2}} , … , {m}_{{obj}_{T}} \} ( T = 0 , 1 , 2 , … , T ) ;$$

the second input parameter is the mask template sequence that includes the object initial mask template of the to-be-processed image, and each mask template in the mask template sequence may be an object initial mask template corresponding to a corresponding to-be-processed image. For example, m_{obj}_{₁} is the object initial mask template of xₘ₁.

The trained information propagation model is denoted as F_{T}, the first inpainting image for which inpainting is completed is denoted as x_{tcomp}, the object target mask template is denoted as m_{obj}_{_{compt}}, and the image initial mask template is denoted as m_{blur}. In this case:

$${x}_{tcomp} , {m}_{b lur} , {m}_{{obj}_{comp}} = {F}_{T} ( {x}_{m} , {m}_{obj} ) .$$

Operation S1203: Determine whether a first quantity of initial blurred pixels included in the image initial mask template reaches a first threshold, and if yes, perform operation S1204; otherwise, perform operation S1210.
Operation S1204: Perform morphological processing on a blurred region corresponding to the initial blurred pixel to obtain an image target mask template.
Operation S1205: Determine whether a second quantity of intermediate blurred pixels included in the image target mask template reaches a second threshold, and if yes, perform operation S1206; otherwise, perform operation S1210.
Operation S1206: Input the image target mask template and the first inpainting image into a trained image inpainting model, and obtain a second inpainting image by using the trained image inpainting model.
Operation S1207: Determine whether a contour of the second-type object included in the object initial mask template and a contour of the second-type object included in the object target mask template are consistent, and if yes, perform operation S1211; otherwise, perform operation S1208.
Operation S1208: Input the second inpainting image and the object target mask template into a trained object inpainting model, and obtain a third inpainting image by using the trained object inpainting model.
Operation S1209: Use the third inpainting image as a target inpainting image corresponding to the to-be-processed image.
Operation S1210: Use the first inpainting image as the target inpainting image corresponding to the to-be-processed image.
Operation S1211: Use the second inpainting image as the target inpainting image corresponding to the to-be-processed image.

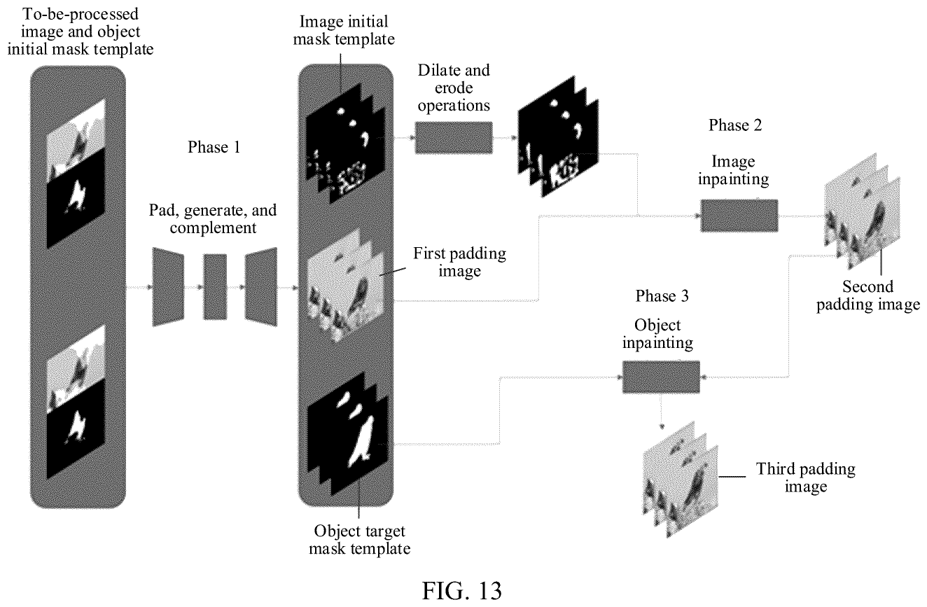

Referring to FIG. 13, FIG. 13 is corresponding to FIG. 12. FIG. 13 provides a schematic diagram of a specific implementation method for image processing according to an embodiment of the present disclosure.

It may be learned from FIG. 13 that an image processing process is divided into three phases according to a used model. The following describes the three phases in detail.

Phase 1: Input a to-be-processed image and an object initial mask template into a trained information propagation model; in the trained information propagation model, based on inter-frame reference information, use an available pixel of a corresponding region in another video frame image that is continuous with the to-be-processed image to perform inter-frame reference information inpainting on the to-be-processed image, where the trained information propagation model has a certain image generation capability at the same time, a pixel part that has no available pixel in another video frame image is generated by using the image generation capability, and pixel generation is performed by using information in space and time domain, so as to complete image inpainting, and obtain a first inpainting image; in addition, the trained information propagation model further has an object complementation capability, and contour complementation processing is performed on a second-type object in the to-be-processed image by using the object complementation capability, to obtain an object target mask template; in addition, the trained information propagation model may further determine an image initial mask template corresponding to an initial blurred region based on the inpainted image; and finally, the trained information propagation model in phase 1 simultaneously outputs the first inpainting image, an image initial mask template corresponding to an initial blurred region whose inpainting result is blurred in the first inpainting image, and the object target mask template.

Phase 2: First, determine a first quantity of initial blurred pixels in the initial blurred region in the image initial mask template, then determine whether the first quantity is greater than a first threshold, and if the first quantity of the initial blurred pixels in the initial blurred region is less than the first threshold, ignore the initial blurred region, output the first inpainting image as a target inpainting image, and perform no subsequent processing; if the first quantity of the initial blurred pixels in the initial blurred region reaches the first threshold, connect scattered initial blurred regions by using a dilation and erosion operation to obtain a processed image target mask template, after the image target mask template is obtained, determine a second quantity of intermediate blurred pixels in the blurred region in the image target mask template, then determine whether the second quantity is greater than a second threshold, and if the second quantity of the intermediate blurred pixels is less than the second threshold, ignore the blurred region, output the first inpainting image as the target inpainting image, and perform no subsequent processing; and if the second quantity of the intermediate blurred pixels reaches the second threshold, invoke an image inpainting model to inpaint a pixel position of the blurred region in the image target mask template on the first inpainting image based on the processed image target mask template.

Phase 3: On the basis of phase 2, if a quantity of pixels, changed in the mask region of the second-type object, of the object target mask template relative to the object initial mask template is less than a third threshold, consider that the mask region of the second-type object has no object contour that needs to be complemented, and use a second inpainting image as a target inpainting image; and if the quantity of pixels, changed in the mask region of the second-type object, of the object target mask template relative to the object initial mask template reaches the third threshold, invoke an object inpainting model to inpaint pixels of the mask region of the second-type object, cover inpainting content of an image inpainting module, obtain a third inpainting image, and use the third inpainting image as the target inpainting image.

In the present disclosure, the first inpainting image, the image initial mask template, and the object target mask template are determined based on the to-be-processed image and the object initial mask template by using the trained information propagation model, and reference pixel propagation is implemented based on the trained information propagation model, so that image content in which complex movement occurs in a background is better inpainted. After the image element is inpainted, the first inpainting image is obtained. To ensure accuracy of image processing in the image inpainting process, when it is determined that the first quantity of the initial blurred pixels included in the image initial mask template reaches the first threshold, morphological processing is performed on the blurred region corresponding to the initial blurred pixel to obtain the image target mask template, so that scattered initial blurred regions are connected, and the blurred region is more regular, thereby improving accuracy of determining. Then, the second quantity of the intermediate blurred pixels included in the image target mask template is determined. When the second quantity reaches the second threshold, in the first inpainting image, inpainting processing is performed on the pixel region corresponding to the intermediate blurred pixel by using the image inpainting model to obtain the second inpainting image, and inpainting processing is performed on the blurred region in the first inpainting image, that is, the blurred region in the first inpainting image is enhanced. Finally, when it is determined that the contour of the second-type object in the object initial mask template is inconsistent with the contour of the second-type object in the object target mask template, in the second inpainting image, inpainting processing is performed on the pixel region corresponding to the second-type object by using the object inpainting model to obtain the third inpainting image, so that inpainting processing is performed on a occluded object region, that is, the blurred region in the second inpainting image is enhanced. Inpainting processing is performed on a blurred region with blurred inpainting caused by a complex texture and an object occlusion condition, and enhancement processing is performed on the blurred region, thereby improving image quality of a target inpainting image.

In this embodiment of the present disclosure, in a process of performing image processing on the to-be-processed image, the trained information propagation model, the trained image inpainting model, and the trained object inpainting model are involved. Before the model is used, model training needs to be performed to ensure accuracy of model output. The following describes a model training process in detail.

### I. Information Propagation Model

In this embodiment of the present disclosure, a trained information propagation model is obtained after cyclic iterative training is performed on a to-be-trained information propagation model according to a training sample in a training sample data set.

The following uses one cyclic iterative process as an example to describe a training process of the to-be-trained information propagation model.

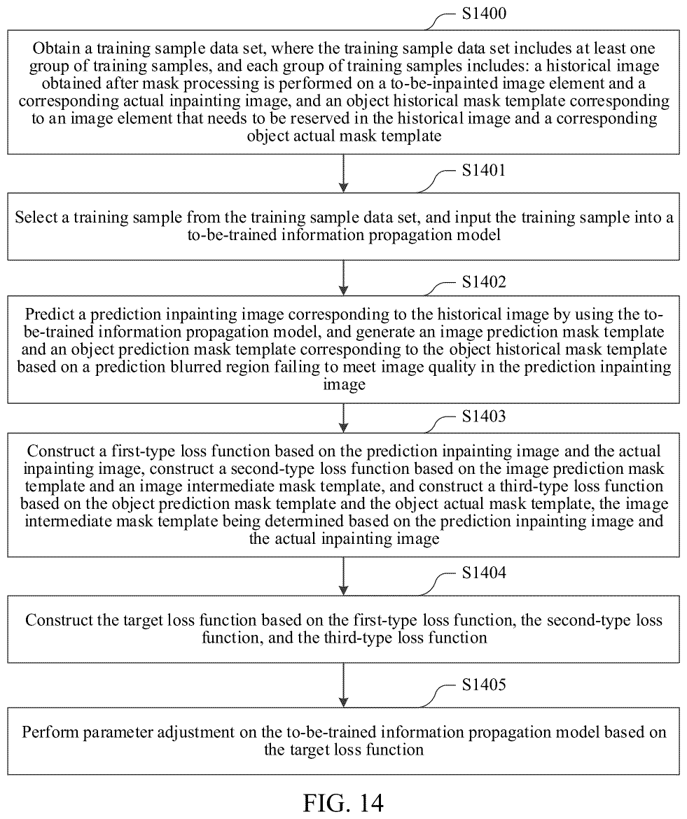

Referring to FIG. 14, FIG. 14 is a training method for an information propagation model according to an embodiment of the present disclosure, including the following operations:
Operation S1400: Obtain a training sample data set, where the training sample data set includes at least one group of training samples, and each group of training samples includes: a historical image obtained after mask processing is performed on an image element for inpainting and a corresponding actual inpainting image, and an object historical mask template corresponding to an image element that needs to be reserved in the historical image and a corresponding object actual mask template.
Operation S1401: Select a training sample from the training sample data set, and input the training sample into a to-be-trained information propagation model.
Operation S1402: Predict a prediction inpainting image corresponding to the historical image by using the to-be-trained information propagation model, and generate an image prediction mask template and an object prediction mask template corresponding to the object historical mask template based on a prediction blurred region in the prediction inpainting image.
Operation S1403: Construct a first-type loss function based on the prediction inpainting image and the actual inpainting image, construct a second-type loss function based on the image prediction mask template and an image intermediate mask template, and construct a third-type loss function based on the object prediction mask template and the object actual mask template, the image intermediate mask template being determined based on the prediction inpainting image and the actual inpainting image.

In one embodiment, the first-type loss function is determined in the following manner:
determining a first sub-loss function based on an image difference pixel value between the prediction inpainting image and the actual inpainting image; that is, the first sub-loss function is constructed by using a loss L₁, and the first sub-loss function is denoted as L₁^{tcomp};
determining a second sub-loss function based on a second comparison result between the prediction inpainting image and the actual inpainting image, the second comparison result being configured for indicating whether the prediction inpainting image is consistent with the actual inpainting image; that is, the second sub-loss function is constructed by using an adversarial loss L_{gen}, and the second sub-loss function is denoted as L_{gen}^{tcomp}; and
determining the first-type loss function based on the first sub-loss function and the second sub-loss function.

In one embodiment, the second-type loss function is determined in the following manner:
determining a third sub-loss function based on a mask difference pixel value between the image prediction mask template and the image intermediate mask template, and using the third sub-loss function as the second-type loss function. The image prediction mask template is obtained when a pixel quantity \tilde{d}ₜ of a prediction blurred region in the prediction inpainting image is greater than a specified threshold.

That is, the third sub-loss function is constructed by using a loss L₁, and the third sub-loss function is denoted as L₁^{blur}. In addition:

$${L}_{1}^{b l u r} = {\sum }_{t = 0}^{t = T} {\sum }_{c = 0}^{H * W - 1} \vert {d}_{t} - {\tilde{d}}_{t} \vert .$$

c is RGB3 channels, H*W represents a matrix with a size of H*W, \tilde{d}ₜ is denoted as a prediction value of dₜ, dₜ is an actual difference between the prediction inpainting image and the actual inpainting image, that is, the pixel quantity of the prediction inpainting image compared with the actual blurred region in the actual inpainting image, dₜ=Σ_{c=0}²|x_{tcomp}_{_{t′}}−yₜ|, x_{tcomp}_{_{t′}} represents the prediction inpainting image, and yₜ is the actual inpainting image.

In one embodiment, the third-type loss function is determined in the following manner:
determining a fourth sub-loss function based on an object difference pixel value between the object prediction mask template and a historical object actual mask template; that is, the fourth sub-loss function is constructed by using a loss L₁, the fourth sub-loss function is denoted as L₁^{obj}, and

$${L}_{1}^{obj} = {\sum }_{t = 0}^{T} {L}_{1}^{obj} ( {m}_{{obj}_{c o m {p}_{t}}} , {m}_{{obj}_{{full}_{t}}} ) ,$$

where

$${m}_{{obj}_{{comp}_{t}}}$$

represents the object prediction mask template, and

$${m}_{{obj}_{{full}_{t}}}$$

represents the historical object actual mask template;
determining a fifth sub-loss function based on similarity between the object prediction mask template and the historical object actual mask template; that is, the fifth sub-loss function is constructed by using a dice loss L_{dice}, the fifth sub-loss function is denoted as L_{dice}^{obj}, and

$${L}_{dice}^{obj} = {\sum }_{t = 0}^{T} {L}_{dice}^{obj} ( {m}_{{obj}_{c o m {p}_{t}}} , {m}_{{obj}_{{full}_{t}}} ) ,$$

where

$${m}_{{obj}_{{comp}_{t}}}$$

represents the object prediction mask template, and

$${m}_{{obj}_{{full}_{t}}}$$

represents the historical object actual mask template; and
determining the third-type loss function based on the fourth sub-loss function and the fifth sub-loss function.

Operation S1404: Construct the target loss function based on the first-type loss function, the second-type loss function, and the third-type loss function.

The target loss function is:

$${L}^{stage 1} = {λ}_{1}^{tcomp} {L}_{1}^{tcomp} + {λ}_{g e n}^{tcomp} {L}_{g e n}^{tcomp} + {λ}_{1}^{b l u r} {L}_{1}^{b l u r} + {λ}_{1}^{obj} {L}_{1}^{obj} + {λ}_{dice}^{obj} {L}_{dice}^{obj}$$

Operation S1405: Perform parameter adjustment on the to-be-trained information propagation model based on the target loss function.

### II. Image Inpainting Model

In this embodiment of the present disclosure, the image inpainting model selects an image generation tool configured for a blurred region, such as a latent diffusion model (LDM) or large mask inpainting (LaMa).

When the LDM model is being trained, an original image, an image mask template corresponding to the original image, a guide text, and a target image are inputted into the to-be-trained LDM model, and a foreground part and a background part are repeatedly mixed in the LDM model based on the guide text to obtain a prediction image. A loss function is constructed based on the prediction image and the original image, and parameter adjustment is performed on the to-be-trained LDM model based on the loss function. The foreground part is a part that needs to be inpainted, and the background part is another part in the original image different from the part that needs to be inpainted. The target image is an image that meets an inpainting standard after image inpainting is performed on the original image.

When the LaMa model is being trained, an original image, an image mask template corresponding to the original image, and a target image are inputted into the to-be-trained LaMa model, and the original image including an image mask and the image mask of the original image are superimposed in the LaMa model to obtain a 4-channel image. After a down-sampling operation is performed on the 4-channel image, fast Fourier convolution processing is performed, and after fast Fourier processing is performed, an up-sampling operation is performed to obtain a prediction image. An adversarial loss is constructed based on the original image and the prediction image, a loss function is constructed based on a perceptual loss of a receptive field, and parameter adjustment is performed on the to-be-trained LaMa model based on the loss function. The receptive field is a size of a region mapped on the original image on a feature graph outputted by a convolutional neural network through each layer.

### III. Object Inpainting Model

In this embodiment of the present disclosure, an object inpainting model uses transformer as a model of a network structure, for example, STTN.

When the object inpainting model is being trained, an original image and an original image that includes a mask region are inputted into the to-be-trained object inpainting model, and a prediction image is obtained by simultaneously padding, in the object inpainting model, mask regions in all inputted images with self-attention. A loss function is constructed based on the prediction image and the original image, and parameter adjustment is performed on the to-be-trained object inpainting model based on the loss function. The loss function in the training process uses a loss L₁ and an adversarial loss L_{gen}.

The models involved in the embodiments of the present disclosure may be independently trained, or may be jointly trained.

In the embodiments of the present disclosure, training modes for an information propagation model, an image inpainting model, and an object inpainting model are proposed, so as to represent accuracy of output results of the information propagation model, the image inpainting model, and the object inpainting model. Further, in the embodiments of the present disclosure, in an image processing process, when the model is configured for processing, accuracy of image processing and image quality of a processed video frame image are improved.

Based on the same inventive concept as the embodiments of the present disclosure, an embodiment of the present disclosure further provides an image processing apparatus. A principle of solving a problem by the apparatus is similar to that of the method in the foregoing embodiment. Therefore, for implementation of the apparatus, references may be made to implementation of the foregoing method, and details are not described again.

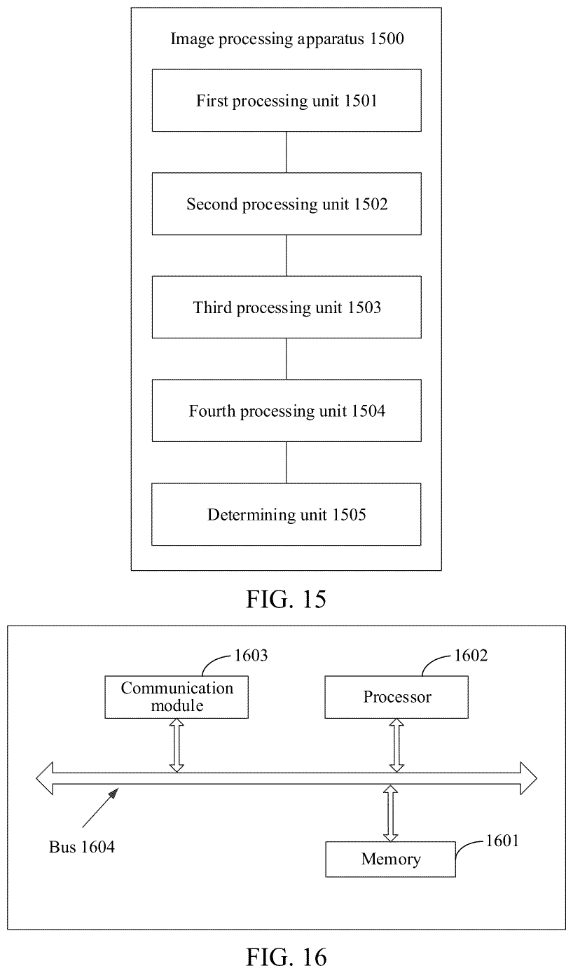

Referring to FIG. 15, FIG. 15 exemplarily provides an image processing apparatus 1500 according to an embodiment of the present disclosure. The image processing apparatus 1500 includes:
a first processing unit 1501, configured to perform mask processing on a first-type object included in an obtained target video frame image, to obtain a to-be-processed image after mask processing; the first-type object being an image element for inpainting; a second processing unit 1502, configured to: perform inpainting processing on the first-type object in the to-be-processed image to obtain a first inpainting image, and generate a corresponding image initial mask template based on an initial blurred region in the first inpainting image; a third processing unit 1503, configured to: perform, when a first quantity of initial blurred pixels included in the image initial mask template reaches a first threshold, morphological processing on an initial blurred region corresponding to the initial blurred pixel to obtain an image target mask template; a fourth processing unit 1504, configured to: perform, when a second quantity of intermediate blurred pixels included in the image target mask template reaches a second threshold, inpainting processing on a pixel region corresponding to the intermediate blurred pixel in the first inpainting image, to obtain a second inpainting image; and a determining unit 1505, configured to determine a target inpainting image corresponding to the to-be-processed image based on the second inpainting image.

In one embodiment, the second processing unit 1502 is specifically configured to: input a video sequence including the to-be-processed image into a trained information propagation model; and perform, in the trained information propagation model, inpainting processing on the first-type object in the to-be-processed image based on an image element in another video frame image in the video sequence to obtain the first inpainting image, and generate a corresponding image initial mask template based on the initial blurred region in the first inpainting image.

In one embodiment, the second processing unit 1502 is specifically configured to: input an object initial mask template into the trained information propagation model, the object initial mask template being determined after identifying a second-type object included in the video frame image, and the second-type object being an image element that needs to be reserved; and perform, in the trained information propagation model, object contour complementation processing on the second-type object in the object initial mask template to obtain an object target mask template.

In one embodiment, the determining unit 1505 is specifically configured to: compare the object initial mask template with the object target mask template to obtain a first comparison result, the first comparison result being configured for indicating whether contours of the second-type objects are consistent; and process the second inpainting image based on the first comparison result, to obtain the target inpainting image.

In one embodiment, the determining unit 1505 is specifically configured to: perform, if the first comparison result indicates that the contours of the second-type objects are inconsistent, inpainting processing on a pixel region corresponding to the second-type object in the second inpainting image to obtain a third inpainting image, and use the third inpainting image as the target inpainting image; and use the second inpainting image as the target inpainting image if the first comparison result indicates that the contours of the second-type objects are consistent.

In one embodiment, the trained information propagation model is trained in the following manner: performing cyclic iterative training on a to-be-trained information propagation model according to a training sample in a training sample data set to obtain the trained information propagation model, where the following operations are performed in one cyclic iterative process: selecting a training sample from the training sample data set; the training sample being: a historical image obtained after mask processing is performed on an image element for inpainting, and an object historical mask template corresponding to an image element that needs to be reserved in the historical image; inputting the training sample into the information propagation model, predicting a prediction inpainting image corresponding to the historical image, and generating an image prediction mask template and an object prediction mask template corresponding to the object historical mask template based on a prediction blurred region in the prediction inpainting image; and performing parameter adjustment on the information propagation model by using a target loss function constructed based on the prediction inpainting image, the image prediction mask template, and the object prediction mask template.

In one embodiment, the training sample further includes: an actual inpainting image corresponding to the historical image, and an object actual mask template corresponding to the object historical mask template; and the target loss function is constructed in the following manner: constructing a first-type loss function based on the prediction inpainting image and the actual inpainting image, constructing a second-type loss function based on the image prediction mask template and an image intermediate mask template, and constructing a third-type loss function based on the object prediction mask template and the object actual mask template, the image intermediate mask template being determined based on the prediction inpainting image and the actual inpainting image; and constructing the target loss function based on the first-type loss function, the second-type loss function, and the third-type loss function.

In one embodiment, the first-type loss function is determined in the following manner: determining a first sub-loss function based on an image difference pixel value between the prediction inpainting image and the actual inpainting image; determining a second sub-loss function based on a second comparison result between the prediction inpainting image and the actual inpainting image, the second comparison result being configured for indicating whether the prediction inpainting image is consistent with the actual inpainting image; and determining the first-type loss function based on the first sub-loss function and the second sub-loss function.

In one embodiment, the second-type loss function is determined in the following manner: determining a third sub-loss function based on a mask difference pixel value between the image prediction mask template and the image intermediate mask template, and using the third sub-loss function as the second-type loss function.

In one embodiment, the third-type loss function is determined in the following manner: determining a fourth sub-loss function based on an object difference pixel value between the object prediction mask template and a historical object actual mask template; determining a fifth sub-loss function based on similarity between the object prediction mask template and the historical object actual mask template; and determining the third-type loss function based on the fourth sub-loss function and the fifth sub-loss function.

In one embodiment, after generating the corresponding image initial mask template, the second processing unit 1502 is further configured to: use the first inpainting image as the target inpainting image corresponding to the to-be-processed image when the first quantity of the initial blurred pixels included in the image initial mask template is less than the first threshold.

In one embodiment, after obtaining the image target mask template, the third processing unit 1503 is further configured to: use the first inpainting image as the target inpainting image corresponding to the to-be-processed image when the second quantity of the intermediate blurred pixels included in the image target mask template is less than the second threshold.

For convenience of description, the foregoing parts are divided into units (or modules) for description by function. Certainly, in implementation of the present disclosure, the functions of the units (or modules) may be implemented in the same piece of or a plurality of pieces of software and/or hardware.

A person skilled in the art can understand that the aspects of the present disclosure may be implemented as systems, methods, or program products. Therefore, the aspects of the present disclosure may be specifically embodied in the following forms: hardware only implementations, software only implementations (including firmware, micro code, etc.), or implementations with a combination of software and hardware, which are collectively referred to as “circuit”, “module”, or “system” herein.

After introducing the image processing method and apparatus in the exemplary implementation of the present disclosure, the following describes an electronic device configured for image processing according to another exemplary implementation of the present disclosure.

Based on the same inventive concept as the foregoing method embodiments of the present disclosure, an embodiment of the present disclosure further provides an electronic device, and the electronic device may be a server. In this embodiment, a structure of the electronic device may be shown in FIG. 16, including a memory 1601, a communication module 1603, and one or more processors 1602.

The memory 1601 is configured to store a computer program executed by the processor 1602. The memory 1601 may mainly include a program storage region and a data storage region, where the program storage region may store an operating system, a program required for running an instant messaging function, and the like. The data storage area can store various instant messaging information and operation instruction sets.

The memory 1601 may be a volatile memory such as a random access memory (RAM); the memory 1601 may alternatively be a non-volatile memory such as a read-only memory, a flash memory, a hard disk drive (HDD), or a solid-state drive (SSD); or the memory 1601 is any other medium that can be configured for carrying or storing an expected computer program in the form of an instruction or data structure and that can be accessed by a computer, but is not limited thereto. The memory 1601 may be a combination of the foregoing memories.

The processor 1602 may include one or more central processing units (CPU), a digital processing unit, or the like. The processor 1602 is configured to implement the foregoing image processing method when invoking the computer program stored in the memory 1601.

The communication module 1603 is configured to communicate with a terminal device and another server.

A specific connection medium among the memory 1601, the communication module 1603, and the processor 1602 is not limited in this embodiment of the present disclosure. In this embodiment of the present disclosure, the memory 1601 is connected to the processor 1602 by using a bus 1604 in FIG. 16. The bus 1604 is described by using a bold line in FIG. 16. A connection manner between other components is merely a schematic description, and is not limiting. The bus 1604 may be classified into an address bus, a data bus, a control bus, and the like. For ease of description, in FIG. 16, only one bold line is configured for description, but this does not mean that only one bus or one type of bus exists.

The memory 1601 stores a computer storage medium, the computer storage medium stores computer executable instructions, and the computer executable instructions are configured for implementing the image processing method in this embodiment of the present disclosure. The processor 1602 is configured to execute the foregoing image processing method.

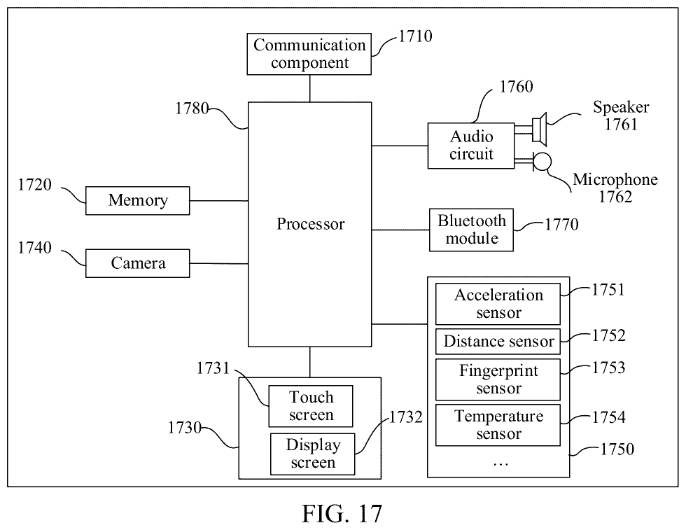

In another embodiment, the electronic device may alternatively be another electronic device, such as the terminal device 310 shown in FIG. 3. In this embodiment, the structure of the electronic device may be shown in FIG. 17, including: a communication component 1710, a memory 1720, a display unit 1730, a camera 1740, a sensor 1750, an audio circuit 1760, a Bluetooth module 1770, a processor 1780, and the like.

The communication component 1710 is configured to communicate with the server. In some embodiments, a circuit wireless fidelity (Wi-Fi) module may be included. The Wi-Fi module belongs to a short-range wireless transmission technology, and the electronic device may help a user to send and receive information by using the Wi-Fi module.

The memory 1720 may be configured to store a software program and data. The processor 1780 runs the software program and the data stored in the memory 1720, to implement various functions and data processing of the terminal device 310. The memory 1720 may include a high speed random access memory, and may also include a non-volatile memory, such as at least one magnetic disk storage device, a flash memory, or another volatile solid-state storage device. The memory 1720 stores an operating system that enables the terminal device 310 to run. In the present disclosure, the memory 1720 may store an operating system and various application programs, and may further store code for executing the image processing method in this embodiment of the present disclosure.

The display unit 1730 may be further configured to display information entered by a user or information provided for the user and graphical user interfaces (GUI) of various menus of the terminal device 310. Specifically, the display unit 1730 may include a display screen 1732 disposed on a front face of the terminal device 310. The display screen 1732 may be configured in a form of a liquid crystal display, a light emitting diode, or the like. The display unit 1730 may be configured to display a target inpainting image and the like in the embodiments of the present disclosure.

The display unit 1730 may be further configured to receive inputted digital or character information, and generate a signal input related to user settings and function control of the terminal device 310. Specifically, the display unit 1730 may include a touchscreen 1731 disposed on the front face of the terminal device 310, and may collect a touch operation, such as tapping a button or dragging a scroll box, of a user on or near the touchscreen 1731.

The touchscreen 1731 may cover the display screen 1732, or may be integrated with the display screen 1732 to implement an input and output function of the terminal device 310. After integration, the touchscreen 1731 may be referred to as a touch display screen. In the present disclosure, the display unit 1730 may display an application program and corresponding operations.

The camera 1740 may be configured to capture a static image. There may be one or more cameras 1740. An object is projected onto a photosensitive element by using a lens to generate an optical image. The photosensitive element may be a charge coupled device (CCD) or a complementary metal-oxide-semiconductor (CMOS) phototransistor. The photosensitive element converts an optical signal into an electrical signal, and then transmits the electrical signal to the processor 1780 to convert the optical signal into a digital image signal.

The terminal device may further include at least one sensor 1750, such as an acceleration sensor 1751, a distance sensor 1752, a fingerprint sensor 1753, and a temperature sensor 1754. The terminal device may be further configured with another sensor such as a gyroscope, a barometer, a hygrometer, a thermometer, an infrared sensor, an optical sensor, and a motion sensor.

The audio circuit 1760, a speaker 1761, and a microphone 1762 may provide audio interfaces between the user and the terminal device 310. The audio circuit 1760 may convert received audio data into an electric signal and transmit the electric signal to the loudspeaker 1761. The loudspeaker 1761 converts the electric signal into a sound signal and output the sound signal. The terminal device 310 may be further configured with a volume button to adjust volume of a sound signal. In addition, the microphone 1762 converts a collected audio signal into an electrical signal, and the audio circuit 1760 receives the electrical signal, converts the electrical signal into audio data, and then outputs the audio data to the communication component 1710 to send to, for example, another terminal device 310, or outputs the audio data to the memory 1720 for further processing.

The Bluetooth module 1770 is configured to exchange information with another Bluetooth device that has a Bluetooth module by using the Bluetooth protocol. For example, the terminal device may establish a Bluetooth connection to a wearable electronic device (for example, a smart watch) that also has a Bluetooth module by using the Bluetooth module 1770, so as to exchange data.

The processor 1780 is a control center of the terminal device, is connected to each part of the entire terminal by using various interfaces and lines, and performs various functions and data processing of the terminal device by running or executing the software program stored in the memory 1720 and invoking the data stored in the memory 1720. In some embodiments, the processor 1780 may include one or more processing units. The processor 1780 may further integrate an application processor and a baseband processor, where the application processor mainly processes an operating system, a user interface, an application program, and the like, and the baseband processor mainly processes wireless communication. The baseband processor may alternatively not be integrated into the processor 1780. In the present disclosure, the processor 1780 may run an operating system, an application program, user interface display and a touch response, and the image processing method in the embodiment of the present disclosure. In addition, the processor 1780 is coupled to the display unit 1730.

In some embodiments, aspects of the image processing method provided in the present disclosure may further be implemented in a form of a program product. The program product includes a computer program. When the program product runs on an electronic device, the computer program is configured to enable the electronic device to perform the operations in the image processing methods described in the foregoing descriptions according to the exemplary implementations of the present disclosure.

The program product may be any combination of one or more readable mediums. The readable medium may be a computer-readable signal medium or a computer-readable storage medium. The readable storage medium may be, for example, but is not limited to, an electric, magnetic, optical, electromagnetic, infrared, or semi-conductive system, apparatus, or device, or any combination thereof. More specific examples (non-exhaustive lists) of the readable storage medium include: an electrical connection having one or more wires, a portable disk, a hard disk, a random access memory (RAM), a read-only memory (ROM), an erasable programmable read-only memory (EPROM), an optical fiber, a portable compact disk read-only memory (CD-ROM), an optical storage device, a magnetic storage device, or any appropriate combination thereof.

The program product in the implementation of the present disclosure may use a portable compact disk read-only memory (CD-ROM) and include a computer program, and may run on a computing apparatus. However, the program product in the present disclosure is not limited thereto. In this specification, the readable storage medium may be any tangible medium including or storing a program, and the program may be used by or used in combination with an instruction execution system, apparatus, or device.

A readable signal medium may include a data signal being in a baseband or transmitted as a part of a carrier, which carries a computer-readable program. A data signal propagated in such a way may assume a plurality of forms, including, but not limited to, an electromagnetic signal, an optical signal, or any appropriate combination thereof. The readable storage medium may alternatively be any readable medium other than a readable storage medium, and the readable medium may send, propagate, or transmit a program used by or in combination with an instruction execution system, apparatus, or device.

The computer program included in the readable medium may be transmitted by using any suitable medium, including but not limited to wireless, wired, optical cable, RF, or the like, or any suitable combination thereof.

Although several units or subunits of the apparatus are mentioned in the foregoing detailed description, such division is merely exemplary and not mandatory. Actually, according to the implementations of the present disclosure, the features and functions of two or more units described above may be specifically implemented in one unit. On the contrary, the features and functions of one unit described above may be further divided to be embodied by a plurality of units.

In addition, although operations of the methods of the present disclosure are described in a specific order in the accompanying drawings, this does not require or imply that these operations need to be performed in the specific order, or that all the operations shown need to be performed to achieve an expected result. Additionally or alternatively, some operations may be omitted, multiple operations are combined into one operation for execution, and/or one operation is decomposed into multiple operations for execution.

A person skilled in the art can understand that the embodiments of the present disclosure may be provided as a method, a system, or a computer program product. Therefore, the present disclosure may use a form of hardware-only embodiments, software-only embodiments, or embodiments combining software and hardware. In addition, the present disclosure may be in a form of a computer program product implemented on one or more computer-available storage media (including but not limited to a magnetic disk memory, a CD-ROM, an optical memory, and the like) that include a computer-available computer program.

Although exemplary embodiments of the present disclosure have been described, once persons skilled in the art know the basic creative concept, they can make additional changes and modifications to these embodiments. Therefore, the following claims are intended to be construed as to cover the exemplary embodiments and all changes and modifications falling within the scope of the present disclosure.

Clearly, a person skilled in the art can make various modifications and variations to the present disclosure without departing from the spirit and scope of the present disclosure. In this case, if the modifications and variations made to the present disclosure fall within the scope of the claims of the present disclosure and their equivalent technologies, the present disclosure is intended to include these modifications and variations.

What is claimed is:

1. An image processing method, performed by a computer device, the method comprising:
performing mask processing on a first-type object comprised in an obtained target video frame image, to obtain a candidate image after mask processing; the first-type object being an image element for inpainting;
performing inpainting processing on the first-type object in the candidate image to obtain a first inpainting image, and generating an image initial mask template based on an initial blurred region in the first inpainting image;
performing, when a first quantity of initial blurred pixels comprised in the image initial mask template reaches a first threshold, morphological processing on an initial blurred region corresponding to the initial blurred pixel to obtain an image target mask template;
performing, when a second quantity of intermediate blurred pixels comprised in the image target mask template reaches a second threshold, inpainting processing on a pixel region corresponding to the intermediate blurred pixel in the first inpainting image, to obtain a second inpainting image; and
determining a target inpainting image corresponding to the candidate image based on the second inpainting image.

2. The method according to claim 1, wherein the performing inpainting processing on the first-type object in the candidate image to obtain a first inpainting image, and generating a corresponding image initial mask template based on an initial blurred region in the first inpainting image comprises:
inputting a video sequence comprising the candidate image into a trained information propagation model; and
performing, in the trained information propagation model, inpainting processing on the first-type object in the candidate image based on an image element in another video frame image in the video sequence to obtain the first inpainting image, and generating a corresponding image initial mask template based on the initial blurred region in the first inpainting image.

3. The method according to claim 2, wherein the method further comprises:
inputting an object initial mask template into the trained information propagation model, the object initial mask template being determined after identifying a second-type object comprised in the video frame image, and the second-type object being an image element that needs to be reserved; and
performing, in the trained information propagation model, object contour complementation processing on the second-type object in the object initial mask template to obtain an object target mask template.

4. The method according to claim 3, wherein the determining a target inpainting image corresponding to the candidate image based on the second inpainting image comprises:
comparing the object initial mask template with the object target mask template to obtain a first comparison result, the first comparison result indicating whether contours of the second-type objects are consistent; and
processing the second inpainting image based on the first comparison result, to obtain the target inpainting image.

5. The method according to claim 4, wherein the processing the second inpainting image based on the first comparison result, to obtain the target inpainting image comprises:
performing, if the first comparison result indicates that the contours of the second-type objects are inconsistent, inpainting processing on a pixel region corresponding to the second-type object in the second inpainting image to obtain a third inpainting image, and using the third inpainting image as the target inpainting image; and
using the second inpainting image as the target inpainting image if the first comparison result indicates that the contours of the second-type objects are consistent.

6. The method according to claim 2, wherein the trained information propagation model is trained by:
performing cyclic iterative training on a to-be-trained information propagation model according to a training sample in a training sample data set to obtain the trained information propagation model, wherein the following operations are performed in one cyclic iterative process:
selecting a training sample from the training sample data set; the training sample comprising: a historical image obtained after mask processing is performed on an image element for inpainting, and an object historical mask template corresponding to an image element that needs to be reserved in the historical image;
inputting the training sample into the information propagation model, predicting a prediction inpainting image corresponding to the historical image, and generating an image prediction mask template and an object prediction mask template corresponding to the object historical mask template based on a prediction blurred region in the prediction inpainting image; and
performing parameter adjustment on the information propagation model by using a target loss function constructed based on the prediction inpainting image, the image prediction mask template, and the object prediction mask template.

7. The method according to claim 6, wherein the training sample further comprises: an actual inpainting image corresponding to the historical image, and an object actual mask template corresponding to the object historical mask template; and
the target loss function of the information propagation model is constructed by:
constructing a first-type loss function based on the prediction inpainting image and the actual inpainting image, constructing a second-type loss function based on the image prediction mask template and an image intermediate mask template, and constructing a third-type loss function based on the object prediction mask template and the object actual mask template, the image intermediate mask template being determined based on the prediction inpainting image and the actual inpainting image; and
constructing the target loss function based on the first-type loss function, the second-type loss function, and the third-type loss function.

8. The method according to claim 7, wherein the first-type loss function is determined by:
determining a first sub-loss function based on an image difference pixel value between the prediction inpainting image and the actual inpainting image;
determining a second sub-loss function based on a second comparison result between the prediction inpainting image and the actual inpainting image, the second comparison result indicating whether the prediction inpainting image is consistent with the actual inpainting image; and
determining the first-type loss function based on the first sub-loss function and the second sub-loss function.

9. The method according to claim 8, wherein the second-type loss function is determined by:
determining a third sub-loss function based on a mask difference pixel value between the image prediction mask template and the image intermediate mask template, and using the third sub-loss function as the second-type loss function.

10. The method according to claim 8, wherein the third-type loss function is determined by:
determining a fourth sub-loss function based on an object difference pixel value between the object prediction mask template and a historical object actual mask template;
determining a fifth sub-loss function based on similarity between the object prediction mask template and the historical object actual mask template; and
determining the third-type loss function based on the fourth sub-loss function and the fifth sub-loss function.

11. The method according to claim 1, further comprising:
using the first inpainting image as the target inpainting image corresponding to the candidate image when the first quantity of the initial blurred pixels comprised in the image initial mask template is less than the first threshold.

12. The method according to claim 1, further comprising:
using the first inpainting image as the target inpainting image corresponding to the candidate image when the second quantity of the intermediate blurred pixels comprised in the image target mask template is less than the second threshold.

13. An image processing apparatus, comprising:
at least one memory and at least one processor;
the at least one memory being configured to store a computer program; and
the at least one processor being configured to execute the computer program to implement:
performing mask processing on a first-type object comprised in an obtained target video frame image, to obtain a target image after mask processing; the first-type object being an image element for inpainting;
performing inpainting processing on the first-type object in the candidate image to obtain a first inpainting image, and generating an image initial mask template based on an initial blurred region in the first inpainting image;
performing, when a first quantity of initial blurred pixels comprised in the image initial mask template reaches a first threshold, morphological processing on an initial blurred region corresponding to the initial blurred pixel to obtain an image target mask template;
performing, when a second quantity of intermediate blurred pixels comprised in the image target mask template reaches a second threshold, inpainting processing on a pixel region corresponding to the intermediate blurred pixel in the first inpainting image, to obtain a second inpainting image; and
determining a target inpainting image corresponding to the candidate image based on the second inpainting image.

14. The apparatus according to claim 13, wherein the performing inpainting processing on the first-type object in the candidate image to obtain a first inpainting image, and generating a corresponding image initial mask template based on an initial blurred region in the first inpainting image comprises:
inputting a video sequence comprising the candidate image into a trained information propagation model; and
performing, in the trained information propagation model, inpainting processing on the first-type object in the candidate image based on an image element in another video frame image in the video sequence to obtain the first inpainting image, and generating a corresponding image initial mask template based on the initial blurred region in the first inpainting image.

15. The apparatus according to claim 14, wherein the at least one processor is further configured to implement:
inputting an object initial mask template into the trained information propagation model, the object initial mask template being determined after identifying a second-type object comprised in the video frame image, and the second-type object being an image element that needs to be reserved; and
performing, in the trained information propagation model, object contour complementation processing on the second-type object in the object initial mask template to obtain an object target mask template.

16. The apparatus according to claim 15, wherein the determining a target inpainting image corresponding to the candidate image based on the second inpainting image comprises:
comparing the object initial mask template with the object target mask template to obtain a first comparison result, the first comparison result indicating whether contours of the second-type objects are consistent; and
processing the second inpainting image based on the first comparison result, to obtain the target inpainting image.

17. The apparatus according to claim 16, wherein the processing the second inpainting image based on the first comparison result, to obtain the target inpainting image comprises:
performing, if the first comparison result indicates that the contours of the second-type objects are inconsistent, inpainting processing on a pixel region corresponding to the second-type object in the second inpainting image to obtain a third inpainting image, and using the third inpainting image as the target inpainting image; and
using the second inpainting image as the target inpainting image if the first comparison result indicates that the contours of the second-type objects are consistent.

18. The apparatus according to claim 13, wherein the at least one processor is further configured to implement:
using the first inpainting image as the target inpainting image corresponding to the candidate image when the first quantity of the initial blurred pixels comprised in the image initial mask template is less than the first threshold.

19. The apparatus according to claim 13, wherein the at least one processor is further configured to implement:
using the first inpainting image as the target inpainting image corresponding to the candidate image when the second quantity of the intermediate blurred pixels comprised in the image target mask template is less than the second threshold.

20. A non-transitory computer-readable storage medium, having a computer program stored therein, the computer program, when executed by at least one processor, causing the at least one processor to implement:
performing mask processing on a first-type object comprised in an obtained target video frame image, to obtain a target image after mask processing; the first-type object being an image element for inpainting;
performing inpainting processing on the first-type object in the candidate image to obtain a first inpainting image, and generating an image initial mask template based on an initial blurred region in the first inpainting image;
performing, when a first quantity of initial blurred pixels comprised in the image initial mask template reaches a first threshold, morphological processing on an initial blurred region corresponding to the initial blurred pixel to obtain an image target mask template;
performing, when a second quantity of intermediate blurred pixels comprised in the image target mask template reaches a second threshold, inpainting processing on a pixel region corresponding to the intermediate blurred pixel in the first inpainting image, to obtain a second inpainting image; and
determining a target inpainting image corresponding to the candidate image based on the second inpainting image.
